(19) United States
(12) Patent Application Publication
(10) Pub. No.: US 2013/0103321 A1
(43) Pub. Date: Apr. 25, 2013

(54) Selection of Preferred Sample Handling and Processing Protocol for Identification of Disease Biomarkers and Sample Quality Assessment

(71) Applicant: SomaLogic, Inc., Boulder, CO (US)

(72) Inventors: Michael Riel-Mehan, Louisville, CO (US); Alex A.E. Stewart, Waltham, MA (US); Glenn Sanders, Boulder, CO (US); Rachel M. Ostroff, Westminster, CO (US); Stephen Alaric Williams, Boulder, CO (US); Edward N. Brody, Boulder, CO (US)

(73) Assignee: SomaLogic, Inc., Boulder, CO (US)

(21) Appl. No.: 13/659,755

(22) Filed: Oct. 24, 2012

Related U.S. Application Data
(60) Provisional application No. 61/550,688, filed on Oct. 24, 2011.

(51) Int. Cl. G06F 19/00

(52) U.S. Cl. CPC G06F 19/34
USPC 702/19; 506/9; 435/29; 703/2; 702/19

(57) ABSTRACT

The subject invention relates to methods for obtaining biological samples of improved quality. It encompasses the identification of markers or proteins in biological samples that are altered due to variations in sample collection, handling and processing. They are also useful for correcting variations in measured results for disease biomarkers. Further, they can permit the rejection of samples or groups of samples as necessary if it is determined that their collection method was not in accordance with the predetermined protocol. Other advantages useful to the skilled artisan are described herein.

### FIELD OF THE INVENTION

In the fields of medical diagnostics and drug development, comparisons are made between the composition of blood and other biological samples from individuals in order to determine and understand those changes which might be related to specific conditions or diseases. For example, biomarkers may indicate the ability to respond to certain medications, the presence of a disease such as cancer, or monitor processes such as the response to treatment or changes in organ function. Once established as reliable and robust, such biomarker measurements may be used clinically.

The key properties for an ideal biomarker measurement required for discovery as a biomarker and for further reaching clinical utility include reliability and robustness.

### BACKGROUND OF THE INVENTION

Blood contains powerful cellular and humoral systems for reacting to injury or foreign and infectious agents. Small challenges can induce the innate immune system (complement system and cells such as macrophages) to release powerful signals and enzymes, lead to activation of the platelets and trigger the coagulation of the blood. In as much as these signals are related to the processes inside the body, they are of interest because they can be directly involved in defense and repair systems and serve as markers for disease. However, such process signals are also responsive to the effects of blood sample preparation. Merely drawing blood from a vessel through a needle, or exposing blood to air can result in unintended activation of these mechanisms. For example, altering the time, centrifuge speed or temperature of sample processing steps can alter the apparent composition of serum or plasma such that physiologic information is masked by the pre-analytic variability imparted on the sample during collection and processing. The strong susceptibility of these processes and proteins to subtle alterations in sample handling of the proteins can compromise their use as biomarkers due to the concomitant lack of robustness.

Currently research efforts in multivariate biology show strong interest in pre-analytical sample variation (often called “batch effects”). Currently the extent to which sample quality can be determined is largely limited to visually obvious changes such as red color indicating red cell lysis, and cloudiness indicating high lipid or other contaminants. This limits the trust that clinicians can put in all but the hardiest and most robust protein measurements. A study documenting some of the complex and nonlinear effects of variations in serum and plasma preparation is described in Ostroff, R. et al. (2010) J. Proteomics 73:649-666. Proposed here are specific techniques that determine the compliance with sample preparation protocol, based on a nonlinear (logarithmic) transformation of measurements of a specific set of proteins affected by variation in sample preparation protocol. Metrics derived from these methods can be used to monitor compliance, reject samples, and make corrections in analytes of interest. These techniques are useful in evaluating the quality of human or animal blood samples used in biomarker research, clinical diagnostic applications, bio-bank sample quality monitoring and drug development. Similar approaches can be developed to assess sample integrity for many other sample types, including urine, cerebrospinal fluid, sputum or tissue.

### SUMMARY

As is described herein, the key properties for an ideal biomarker measurement required for biomarker discovery and for attaining clinical utility include reliability and robustness. Reliability of a biomarker means that the biomarker signal is truthful in capturing the underlying biology of health or disease (i.e., is not a “false positive” marker). Robustness of a biomarker indicates that the biomarkers are differentially expressed in diseased individuals relative to non-diseased individuals. To increase the probability of finding true disease biomarkers, and reduce the change of identifying false positives due to sample bias, a method for measuring sample quality and consistency is essential.

To design a method to assess sample quality, studies were conducted relating to the processes and mechanisms of pre-analytical variation in blood serum and plasma measurements using multi-dimensional proteomic experiments involving intentional manipulation of the parameters of sample handling. In these experiments, it was found that many protein signals are affected by sample preparation artifacts, in addition to proteins known to be directly involved in the defense and repair system processes. Further, other biomarker signals such as gene expression, circulating miRNA and metabolomics can be affected by sample preparation artifacts.

The cellular and enzymatic systems which exist in blood to defend against infection, to grow and repair vessel walls, for communication between organs, and for the moment to moment control of metabolic supply and demand are complex. It has not been possible to fully understand how all of the effects of sample handling protocol variations on biomarker assays are mediated. However, the subject invention describes the correlation of sample handling protocol variations with measureable changes imparted on a sample post-collection.

One might imagine that some techniques are relatively immune to the effects of sample handling, but this is not the case. Even though antibodies work well in the presence of blood plasma and serum matrices, and mass spectrometry can measure peptides and even denatured proteins, if cells in the samples lyse, or if platelets degranulate, or if the complement system is activated, then dramatic changes in analyte concentration will occur in the sample after it has been taken, and any “high fidelity” measurement technique will detect them. Therefore, techniques similar to those described herein for determination of the impact of sample handling variations can be useful for multiple assay formats and biomarkers other than proteins. Such assay formats may be sensitive in different ways, but can be affected by the same underlying causes in terms of sample preparation variation.

The variations of the different steps in blood handling and processing can be shown to affect biological samples in reproducible ways. The sensitivity of each biomarker protein measurement to parameters associated with the various sample handling and processing steps have been quantified using the SOMAmer® proteomic array and markers of variation in sample handling processes have been identified. The sample handling and processing variations have been quantified within the same multianalyte measurement assay for disease biomarker measurements and for developed methods, to determine which handling/processing markers have been affected, and approximately by how much. The subject methods have also made it possible to place limits on acceptable sample handling and processing quality metrics for biomarker discovery.

### BRIEF DESCRIPTION OF THE DRAWINGS

FIG. 1A is a plot of the first two components of the rotation matrix, which reflects the protein variation for PCA on the time-to-spin and time-to-freeze experiment. The analytes in the Cell Abuse sample marker variation (SMV) are indicated with solid dots.

FIG. 1B is a plot of the projection matrix, which reflects sample variation for PCA on the time-to-spin and time-to-freeze experiment. The time-to-spin is indicated with different symbols for the points. The second component shows an ordering of the points from 0.5 hr to 20 hours which is the same direction as the analytes in the serum Cell Abuse SMV.

FIG. 2A is a box and whisker plot of the second PCA component of the time-to-spin and time-to-freeze experiment stratified by time-to-spin. The plot reveals that the second component is strongly associated with time-to-spin. As the time to spin increases, the distance from the half hour time point increases.

FIG. 2B is a box and whisker plot that shows that the serum cell abuse SMV measures the same time to spin effect. It is important to note that signs of PCA coefficients are arbitrary; in this case, the coefficient should be interpreted as a relative distance from the half hour time point.

FIG. 3 is a box and whisker plot of a PCA principal component for a clinical study separated by site. This component reveals differences between the sites, suggesting that even when collection protocols are meant to be identical they vary in sample collection quality. Since PCA arbitrarily gives the signs of the coefficients, the coefficients are increasing unlike the coefficients in FIG. 2A; the analyte variation is in the same direction in both datasets.

FIGS. 4A, 4B, and 4C show sample variation in a multi-collection site cancer study. FIG. 4A is a box and whisker plot of case/control differences in the Cell Abuse SMV stratified by collection site. FIG. 4B is a box and whisker plot of case/control differences in the Complement SMV stratified by collection site. FIG. 4C shows the Complement SMV plotted against the Cell Abuse SMV. Example thresholds for acceptable ranges for these SMV values are denoted by the dotted lines.

FIG. 5A shows the first two components of the rotation matrix, which reflects the protein variation, for PCA on the SHN collection protocol experiment in standard EDTA plasma tubes. The analytes in the Cell Abuse SMV are shown as solid dots.

FIG. 5B shows the projection matrix, which reflects sample variation, for PCA on the SHN collection protocol experiment in standard EDTA plasma tubes. The samples derived from the same individual are represented with the same symbol. The samples align into three columns which have a single sample from each individual, with only one exception; these groups represent the three collection protocols. The solid dots represent replicate internal controls collected under quality conditions.

FIG. 6A is a box and whisker plot of the first PCA component SHN experiment on standard EDTA plasma tubes stratified by sample collection protocol.

FIG. 6B is a box and whisker plot of plasma Cell Abuse SMV calculated on the same protocols, which is very similar to the first principal component in FIG. 6A.

FIG. 7 is a plot of the Plasma Platelet SMV versus the Plasma Cell Abuse SMV for samples with varying collection to centrifugation times.

FIG. 8A shows the second and third components of the rotation matrix, which reflects the protein distribution, for PCA on the SHN collection protocol experiment in standard EDTA plasma tubes. These proteins are not related to sample collection but population variation between the ten individuals in the study.

FIG. 8B shows the projection matrix, which reflects sample variation, for PCA on the SHN collection protocol experiment in standard EDTA plasma tubes. Samples from the same individual are circled and different symbols are given to males and females.

FIG. 9 plots the application of Plasma Cell Abuse SMV to Test Set samples. Dotted lines represent the change in Plasma Cell Abuse SMV as time from collection to plasma separation by centrifugation is extended. The Test Set is in the acceptable range for this SMV and reveals consistent peaks in the time to spin at 2 h, a smaller amount around 24 h, and large proportion of samples in between these two timepoints.

FIG. 10A shows the first two components of the rotation matrix, which reflects the protein variation, for the PCA on the Shear experiment. The plot reveals two major directions of variation, serum versus plasma and shear (cell abuse).

FIG. 10B shows the first two components of the projection matrix, which reflects sample variation, for PCA on the Shear experiment. The plot reveals two major directions of variation, serum versus plasma and shear (cell abuse). Each sample is labeled with the number of times it was sheared.

FIG. 11A shows the serum Cell Abuse SMV scores versus the amount of shear (cell abuse) which was accomplished by passing serum samples through a needle multiple times. This plot shows an increase in measured cell abuse as the amount of cell abuse increases.

FIG. 11B shows the plasma Cell Abuse SMV scores versus the amount of shear (cell abuse) which was accomplished by passing plasma samples through a needle multiple times. This plot shows an increase in measured cell abuse as the amount of cell abuse increases.

FIG. 12A shows the first two components of the rotation matrix, which reflects the protein variation, for the PCA on the TRAP activation experiment. The plot reveals two major directions of variation, time-to-spin and platelet activation.

FIG. 12B shows the first two components of the projection matrix, which reflects sample variation, for PCA on the TRAP activation experiment. The plot reveals two major directions of variation, time-to-spin and platelet activation.

FIG. 13 shows a scatter plot of the Plasma Platelet SMV versus time to spin in hours for the TRAP treated samples and controls. TRAP treated samples have constant high levels of measured platelet activation. Untreated controls have initial low levels of measured platelet activation that increase with time-to-spin.

FIG. 14A shows the effect of hard spin after freezing on plasma Cell Abuse SMV scores. FIG. 14B shows the effect of hard spin after freezing on platelet activation.

### DESCRIPTION OF THE INVENTION

Reference will now be made in detail to representative embodiments of the invention. While the invention will be described in conjunction with the enumerated embodiments, it will be understood that the invention is not intended to be limited to those embodiments. On the contrary, the invention is intended to cover all alternatives, modifications, and equivalents that may be included within the scope of the present invention as defined by the claims.

One skilled in the art will recognize many methods and materials similar or equivalent to those described herein, which could be used in and are within the scope of the practice of the present invention. The present invention is in no way limited to the methods and materials described.

Unless defined otherwise, technical and scientific terms used herein have the same meaning as commonly understood by one of ordinary skill in the art to which this invention belongs. Although any methods, devices, and materials similar or equivalent to those described herein can be used in the practice or testing of the invention, the preferred methods, devices and materials are now described.

All publications, published patent documents, and patent applications cited in this application are indicative of the level of skill in the art(s) to which the application pertains. All publications, published patent documents, and patent applications cited herein are hereby incorporated by reference to the same extent as though each individual publication, published patent document, or patent application was specifically and individually indicated as being incorporated by reference.

As used in this application, including the appended claims, the singular forms “a,” “an,” and “the” include plural references, unless the content clearly dictates otherwise, and are used interchangeably with “at least one” and “one or more.” Thus, reference to “an aptamer” includes mixtures of aptamers, reference to “a probe” includes mixtures of probes, and the like.

As used herein, the term “about” represents an insignificant modification or variation of the numerical value such that the basic function of the item to which the numerical value relates is unchanged.

As used herein, the terms “comprises,” “comprising,” “includes,” “including,” “contains,” “containing,” and any variations thereof, are intended to cover a non-exclusive inclusion, such that a process, method, product-by-process, or composition of matter that comprises, includes, or contains an element or list of elements does not include only those elements but may include other elements not expressly listed or inherent to such process, method, product-by-process, or composition of matter.

As used herein, “biomarker” is used to refer to a target molecule that indicates or is a sign of a normal or abnormal process in an individual or of a disease or other condition in an individual. More specifically, a “biomarker” is an anatomic, physiologic, biochemical, or molecular parameter associated with the presence of a specific physiological state or process, whether normal or abnormal, and, if abnormal, whether chronic or acute. Biomarkers are detectable and measurable by a variety of methods including laboratory assays and medical imaging. When a biomarker is a protein, it is also possible to use the expression of the corresponding gene as a surrogate measure of the amount or presence or absence of the corresponding protein biomarker in a biological sample or methylation state of the gene encoding the biomarker or proteins that control expression of the biomarker.

Biomarker selection for a specific disease state involves first the identification of markers that have a measurable and statistically significant difference in a disease population compared to a control population for a specific medical application. Biomarkers can include secreted or shed molecules that parallel disease development or progression and readily diffuse into the bloodstream from tissue affected by a disease or condition or from surrounding tissues and circulating cells in response to a disease or condition. The biomarker or set of biomarkers identified are generally clinically validated or shown to be a reliable indicator for the original intended use for which it was selected. Biomarkers can comprise a variety of molecules including small molecules, peptides, proteins, and nucleic acids. Some of the key issues that affect the identification of biomarkers include over-fitting of the available data and bias in the data including sample handling protocol variations.

As used herein, “biomarker value”, “value”, “biomarker level”, and “level” are used interchangeably to refer to a measurement that is made using any analytical method for detecting the biomarker in a biological sample and that indicates the presence, absence, absolute amount or concentration, relative amount or concentration, titer, a level, an expression level, a ratio of measured levels, or the like, of, for, or corresponding to the biomarker in the biological sample. The exact nature of the “value” or “level” depends on the specific design and components of the particular analytical method employed to detect the biomarker.

“Disease biomarker control range” or “biomarker control range” are used interchangeably and mean the normal or non-disease range of biomarkers in non-diseased or normal individuals. They are typically derived from a control population.

“Sample”, “case” or “test set” are used interchangeably and mean the individual or case patient who is suspected of being or may be diseased and may ultimately be determined to be diseased or non-diseased.

As used herein, a “sample handling and processing marker,” “handling/processing marker,” “markers sensitive to variations in a sample handling and processing protocol,” “markers sensitive to pre-analytic variability,” and the like are used interchangeably to refer to a marker that has been found by methods described herein, to be sensitive to variations in a sample handling and processing protocol. “Sample handling and processing markers” may or may not include biomarkers.

Sample handling and processing markers can be identified from candidate markers in a control population of normal individuals. Samples obtained from said control population are analyzed for candidate markers to select candidate markers that are sensitive to variations in the sample handling and processing protocol. The variations include, but are not limited to, variations in sample processing time, processing temperature, storage time, storage temperature, storage vessel composition, and other storage conditions, prior to sample assay; variations in the method used to extract the sample from the normal individual, including, but not limited to exposure of the sample to oxygen, bore size of needle used for venipuncture, collection device, collection tube additives; variations in sample processing that include, but are not limited to, centrifugation speed, temperature and time, filtration and filter pore size; collection receptacle or vessel, method of freezing; and the like. Those candidate markers that are identified as substantially sensitive to variations qualify as sample handling and processing markers. The candidate markers comprise a variety of molecules including small molecules, peptides, proteins and nucleic acids.

In some cases, it can be desirable to distinguish in the selected handling/processing markers to remove those that can also be a disease marker or a marker for a particular disease at issue in the assay. On the other hand, it may not be necessary to eliminate a handling/processing marker in such circumstances, if the number of handling/processing markers to be used is larger, e.g., greater than any of about 20, 30, 50 or more.

As used herein, “determining”, “determination”, “detecting” or the like used interchangeably herein, refer to the detecting or quantitation (measurement) of a molecule using any suitable method, including fluorescence, chemiluminescence, radioactive labeling, surface plasmon resonance, surface acoustic waves, mass spectrometry, infrared spectroscopy, Raman spectroscopy, atomic force microscopy, scanning tunneling microscopy, electrochemical detection methods, nuclear magnetic resonance, quantum dots, and the like. “Detecting” and its variations refer to the identification or observation of the presence of a molecule in a biological sample, and/or to the measurement of the molecule's value.

As used herein, a “biological sample”, “sample”, and “test sample” are used interchangeably herein to refer to any material, biological fluid, tissue, or cell obtained or otherwise derived from an individual. This includes blood (including whole blood, leukocytes, peripheral blood mononuclear cells, buffy coat, plasma, serum and dried blood spots collected on filter paper), sputum, tears, mucus, nasal washes, nasal aspirate, breath, urine, semen, saliva, cyst fluid, meningeal fluid, amniotic fluid, glandular fluid, lymph fluid, nipple aspirate, bronchial aspirate, pleural fluid, peritoneal fluid, synovial fluid, joint aspirate, ascite, cells, a cellular extract, and cerebrospinal fluid. This also includes experimentally separated fractions of all of the preceding. For example, a blood sample can be fractionated into serum or into fractions containing particular types of blood cells, such as red blood cells or white blood cells (leukocytes). If desired, a sample can be a combination of samples from an individual, such as a combination of a tissue and fluid sample. The term “biological sample” also includes materials containing homogenized solid material, such as from a stool sample, a tissue sample, or a tissue biopsy, for example. The term “biological sample” also includes materials derived from a tissue culture or a cell culture. Any suitable methods for obtaining a biological sample can be employed; exemplary methods include, e.g., phlebotomy, swab (e.g., buccal swab), lavage, fluid aspiration and a fine needle aspirate biopsy procedure. Samples can also be collected, e.g., by micro dissection (e.g., laser capture micro dissection (LCM) or laser micro dissection (LMD)), bladder wash, smear (e.g., a PAP smear), or ductal lavage. A “biological sample” obtained or derived from an individual includes any such sample that has been processed in any suitable manner after being obtained from the individual.

Further, it should be realized that a biological sample can be derived by taking biological samples from a number of individuals and pooling them or pooling an aliquot of each individual's biological sample.

“Cell Abuse” includes, but not limited to, cellular contamination, cellular lysis, cellular fragmentation, cell fragments, internal cellular components and the like.

“Rejecting a sample” as used herein, can refer to a rejection of a subset, group or collection to which the sample belongs.

As used herein, a “SOMAmer” or “Slow Off-Rate Modified Aptamer” refers to an aptamer having improved off-rate characteristics. SOMAmers can be generated using the improved SELEX methods described in U.S. Publication No. 2009/0004667, now U.S. Pat. No. 7,947,447, entitled “Method for Generating Aptamers with Improved Off-Rates.”

In the subject application, the measurements of marker proteins for sample handling and processing have been measured and found to have definite and reproducible behavior with respect to variations in sample collection and preparation. Many of these behaviors can be understood in terms of the biology of the blood components. For example, PF4, Thrombospondin and Nap2 are released on activation of platelets, and their behavior can be followed through experiments varying parameters of blood sample handling and processing. A central idea here is to use some of the many processing and handling marker proteins which can be measured in each sample, to provide graded responses to variations in the sample collection and steps of sample preparation. In this sense, these handling/processing marker protein signals can be used, for example, to monitor past events in blood sample processing such as delay before centrifugation, centrifuge time and acceleration, efficiency of separating blood sample components and time before freezing. This is different from monitoring the degradation of the biomarker proteins of interest directly, and can be both more sensitive and informative over a wide range. By using the methods described herein, the likely quality of a sample in regard to the changes post draw in specific biomarker proteins of interest can be characterized by applying the handling/processing markers' known sensitivities for each process variation, to the estimated values of the biomarkers. Monitoring of sample processing and handling markers can also be used to correct for the estimated effects of each variation in disease biomarkers by subtracting the sample handling component from the apparent protein concentration. These sample handling and processing biomarker measurements can be used to characterize samples prior to assessment of biomarkers of disease by a variety of measurement systems, including antibody assays, mass spectrometry, and the like.

In this way, some of the biological mechanisms of blood are used to act as clocks, timers and recording devices. For this technique to work, we must be able to distinguish between in vivo biological activation of the various mechanisms, and the activation which occurs after the blood has left the body, or “in vitro” changes. The main tool for distinguishing disease biomarker and handling/processing marker degradation in vivo from that incurred in vitro, is the ability to measure a great many proteins simultaneously, so that the sample can be characterized not merely for a single sample handling/processing variation, but for several. Correlated protein measurements indicative of particular sample handling protocol variations provide a panel of sample handling/processing markers. For example, a slow centrifuge speed will fail to remove platelets from the serum or plasma sample and therefore affect the measurement of proteins which are released from platelets in a predictable fashion, but platelet activation in the body in response to a disease state will also affect released platelet granule proteins, as will partial activation of the coagulation pathway either in vivo or post-collection. Further, plasma cells will be retained in the plasma or serum by low centrifugal force, as would internal (non-granule) platelet proteins. Thus, interpretation of the platelet granule protein signal may also require the integration with other evidence, such as sample cell count, disease state of the donor, sample handling/processing marker values, and the like. This integration is performed by projecting the multivariate protein measurements for a sample into a vector space consisting of 4-10 basis vectors each determined by coefficients for some 30-100 proteins which we have found most useful in quantifying the extent of sample handling and processing variation. The extent to which samples vary in the space determined by these basis vectors forms a proxy for the mishandling of the sample on its journey between the point of collection (e.g., blood vessel) and the lab. Many protein components of these vectors are correlated, and panels can be assembled to represent the changes imparted by variable sample collection and processing. Similarly, new handling/processing markers that correlate with the sample handling/processing markers identified herein, may be discovered as proteomic technology expands.

Principal Components Analysis (PCA) was employed as a method to identify markers correlated with sample handling and processing variation. PCA is a method that reduces data dimensionality by performing a covariance analysis between factors. As such, it is suitable for data sets in multiple dimensions, such as a large experiment in protein or gene expression. PCA uses an orthogonal transformation to convert a set of observations of possibly correlated variables into a set of values of uncorrelated variables called principal components. It is used as a tool in exploratory data analysis and for making predictive models. A central idea of PCA is to reduce the dimensionality of a data set consisting of a large number of interrelated variables, while retaining as much as possible of the variation present in the data set. This is achieved by transforming to a new set of variables, the principal components (PCs), which are uncorrelated, and which are ordered so that the first few retain most of the variation present in all of the original variables (Joliffe I T. (2002) Principal Component Analysis, 2^{nd} Edition. Springer).

The metrics delivered on each sample by our system enables one to reject sets of samples from clinical sites by evaluating a few samples to discover that the sample handling and processing techniques at one or more sites or in some fraction of the samples would have made it hard to measure differences in biomarker proteins of interest. That is, the metrics permit the determination of whether the samples at issue will conceal the true biology of health or disease due to sample handling effects, or whether the sample handling effects would produce a “false positive” biomarker result that was not really a reflection of the underlying biology of health or disease. The sample collection/processing metrics have also provided a window into reliable and robust biomarker discovery. By selecting groups of samples with consistent sample preparation metrics, unintended bias can be minimized and disease specific biomarker discovery enhanced. The metrics can also be used to correct mild sample handling effects by comparison to well collected standard samples. In clinical use, the sample handling metrics can be used to advise sites on their collection procedures, in order to reject some samples before expensive further evaluation, and in order to adjust the measurements or report provided to reflect any uncertainty due to sample handling.

In short, it is now possible to:

1. Determine the form and quantify extent of sample handling variation between samples. This permits the sample set to be triaged and separate out the samples suitable for biomarker discovery.

2. Identify or establish preferred sample handling/processing protocol to substantially reduce or minimize variation among samples.

3. Similarly, the sample handling/processing values of collection sites or batches of samples can be compared to reference sample handling/processing biomarker values to determine if individual sites are compliant with the preferred collection protocols.

4. Sample sets can be examined and compared to reference sample handling/processing biomarker values to determine the extent of expected handling and processing variation which may exist between case and control samples. In this way, subsets of samples can be chosen for comparison on the basis of similar sample collection conditions so that the biomarkers that are identified are a reliable reflection of the underlying biology.

5. Individual samples can be rejected for a diagnostic test if it is determined that the sample was not collected in manner that complies with a preferred handling/processing protocol.

6. The protein measurements of one or more case samples can be adjusted to reflect the sample handling/processing variability.

7. A robust subset of proteins which are less sensitive to sample handling/processing variability can be chosen for clinical or commercial use.

Thus, the invention comprises a method for quantifying the effect of deviations from ideal blood sample collection conditions. This method comprises the identification of biological processes which are influenced by variation in the steps involved in blood sample draw and handling, prior to proteomic assay measurement. These biological processes are monitored by specific lists of analyte (e.g., protein) measurements which are uniquely identified with such processes and which can be monitored. These protein lists are applied quantitatively using projections of logarithmic measurements of protein abundance using protein coefficients specific to each protein being measured. The scores from these projections known as Sample Processing marker SMVs (sample marker variation) can be used to assess the procedural variation blood sample collection on a per sample and per group of samples basis.

In one aspect, the subject invention protects the method by which SMV coefficients are created. Specifically, a method has been identified for quantifying the effect of deviations from ideal blood sample collection conditions. This method comprises the identification of biological processes which are influenced by variation in the steps involved in blood sample draw and handling, prior to proteomic assay measurement. These biological processes are monitored by specific lists of protein measurements which are uniquely identified with such processes and can be monitored by us. These protein lists are applied quantitatively using projections of logarithmic protein of measurements of protein abundance using protein coefficient specific to each protein being measured. The scores from these projections known as SMVs can be used to assess the procedural variation blood sample collection on a per sample and per group of samples basis. These biological processes can be used to monitor variations in blood sample collection conditions and the specific protein vectors can be used to monitor and quantify such biological processes. This provides a quantification of the sample collection variation which is recorded in the sample itself and does not need independent monitoring of variables such as times, temperatures, centrifugation speed; at the time of collection.

To identify the SMV protein components, targeted experiments were used that involved biochemical manipulation of specific biological processes, such as complement activation, platelet activation and cell lysis. These experiments are combined with experiments which alter the conditions the blood sample collection in a manner consistent with clinical practice to uniquely identify biological processes which may be used to quantitatively assess the variation in a clinical sample collection on a per sample basis.

The techniques described herein can be used to evaluate the samples as to the quality of the measurements of proteins involved directly in these biological processes. This provides quantitative measurements of sample quality which can be applied to inform decisions concerning measurements of proteins in these samples that can be affected by sample handling variation but are not simply linked directly to the biological processes that are measured here. For example, general proteolytic activity may be affected by activation of complement and lysis of cells. However, the affected proteins do not form a simple closed group or process and cannot be used to monitor complement and cell lysis since other proteins may have many reasons to vary between samples that are unconnected with sample handling variation, such as disease processes or renal function.

The use of a set of proteins with coefficients to monitor the biological processes and indirectly the variation in sample collection conditions, is an invention which has an advantage over a single protein in that it is less likely to suffer from individual variation and forms an ensemble of measurements which can be interpreted to give a robust estimate of the biological process activation. The use of log scaled measurements permits the monitoring of the relative fold change in the biological process activation and can be simply compared to reference samples using a difference corresponding to a ratio in linear space. This use of logarithms also implicitly scales the proteins measurements such that the differing ranges of concentrations between proteins in the set or vector are automatically normalized when using a reference sample.

The direct application of the SMV calculations to an individual blood sample provides scores which may be interpreted in terms of the biological process or indirectly the deviation of the specific sample collection conditions from the ideal conditions of the reference sample. These scores can then be used to define which samples meet criteria or fall within acceptable limits. This information can be used to reject individual samples. Rejecting individual samples is important during biomarker discovery in order to avoid assigning variation in protein abundance to the disease or process which is under investigation for biomarker discovery when such variation may have been caused by some set of individual set of samples being treated under a different sample collection protocol or conditions.

The SMV scores for individual samples may be used to group sets of samples that correspond to specific ranges of sample collection parameters. This allows one to define matched sets of samples where samples from one set have comparable sample collection procedures and parameters to samples from a previous or different collection study. This ability to form matched sets is invaluable in comparing between groups of samples that may have been collected under different conditions. The SMV scores calculated from individual samples may also be used to correct for variation in the sample handling if the correlated variation in other proteins can be determined and a mathematical model built upon the variation in each protein affected by the processes leading to the variation between samples with different SMV scores.

The rejection of individual samples on the basis of their SMV scores allows the performance of more sensitive biomarker discovery since we know that the differences between samples collected from clinically different individuals refer to the differences between those individuals, not between differences in how the samples were collected. Diagnostic tests involving proteins abundance may be misleading if that variation is due to procedure by which the blood sample was collected and not due to the clinical state of the individual. This is avoided by rejecting samples which do not meet SMV score thresholds corresponding to reasonable sample collection procedural variation.

Many existing sample collections are systematically damaged by variations in sample collection procedure. The SMV scores may be used to quantify such variation within a sample collection or between sample collection sites and can be used to reject whole studies on the basis of variation which may mislead the investigator, such as systematic variation in sample collection between case and control. It is necessary that only a subset of the collection be measured to assess such variation; large savings are possible, in the case that a sample collection is deemed unacceptable. It also possible to monitor sample collection during the sample acquisition stage of a study and thus provide corrective advice and detect non-compliance with study protocols. To monitor variation in existing or ongoing studies it is only necessary to measure some sub-sample of the entire collection.

These techniques for monitoring and assessing sample collection variation may be applied to the optimization of study protocols and may be applied to the economic maximization of large sample collection efforts such as bio-banks where the cost of employing special sample collection equipment and vessels may be compared with an accurate assessment of the variation and damage due to operating with a less expensive protocol.

In some cases, it not possible to obtain pristine sample collections, possibly due to the retrospective nature of most common collections of biological samples. And some comparisons may perforce occur between samples collected at different sites and between groups of samples collected at different times. These sample collections will show differences in collection procedure which will cause variations in the proteomic profiles which will be confounded with the intended differential clinical comparison. By creating matched sets between the sample groups, it is possible to compare equivalently collected subsets of samples.

Thus, the subject invention comprises a method of identifying a sample handling/processing marker useful in quantifying sample quality, wherein the method comprises (a) determining a first set of analytes that are differentially expressed when a handling/processing protocol is varied; (b) determining a subset of those analytes that change such that the analyte measurements are smoothly or linearly related, to the degree of variation applied, wherein the subset can contain the same or less analytes compared to the first set of analytes; (c) building a quantitative model for the dependence between the variation in sample handling protocol and the measurements of analytes from the subset; and (d) providing a metric or score for each sample based upon the quantitative model of step (c).

The invention also comprises another method of identifying a sample handling/processing marker useful in quantifying sample quality. This method involves (a) determining a first set of analytes that are differentially expressed when a specific biological process is experimentally activated or varied, wherein the biological process can include, but is not limited to, platelet activation, cell lysis, complement activation, or coagulation; (b) determining a subset of those analytes that change, wherein analyte measurements of the subset are smoothly or linearly related to the degree of experimental activation of the biological process applied to the sample, and wherein the subset can contain the same or less analytes compared to the first set of analytes; (c) building a quantitative model for the dependence between the degree of experimental activation of the biological process applied to the sample and the analyte measurements from the subset; and (d) providing a metric or score for each sample based upon the quantitative model in step (c).

In a related embodiment, the invention comprises a method of identifying a sample handling/processing marker useful in quantifying sample quality, comprising: (a) determining a first set of analytes that are differentially expressed: (i) when a handling/processing protocol is varied, or (ii) when a specific biological process is experimentally activated or varied;

(b) determining a subset of those analytes that change wherein the analyte measurements are smoothly or linearly related: (i) to the degree of handling/processing protocol variation applied, or (ii) to the degree of experimental activation of a biological process applied to the sample;
wherein the subset can contain the same or less analytes compared to the first set of analytes;
(c) building a quantitative model for the dependence between: (i) the variation in sample handling protocol and the measurements of analytes from the subset; or (ii) the degree of experimental activation of a biological process applied to the sample and the analyte measurements from the subset; and (d) providing a metric or score for each sample based upon the quantitative model of step (c).

The invention further provides a method of determining sample quality of a sample. This method comprises (a) providing the sample's sample handling/processing markers as obtained by the foregoing methods; (b) applying the quantitative model as determined by the foregoing methods to provide a metric or score for this sample, wherein such score indicates to what extent the sample is produced by methods deviating by the preferred protocol; and (c) using the score for any of the following applications:

(i) to reject or accept the sample for diagnostic purposes;

(ii) to reject or accept the sample for biomarker discovery applications;

(iii) to determine the extent of variation from sample handling protocol by comparison with a reference sample;

(iv) to correct for variation in sample handling protocol;

(v) to reject samples, whereby acceptable sample groups for biomarker discovery can be provided; and/or

(vi) to reject samples to avoid misleading results in a diagnostic test setting.

Also provided is a method for selecting a subset of samples suitable for biomarker discovery which includes (a) calculating the quantitative metric for each sample in a set intended for biomarker discovery; (b) rejecting samples of step (a) that fail to meet acceptable ranges for quantitative metric; and (c) rejecting samples of step (a) showing association between the metric and the biological distinction targeted for biomarker discovery.

Another method for selecting a subset of samples suitable for biomarker discovery is provided. This method comprises (a) calculating the quantitative metric for each sample from a plurality of collections of samples; (b) selecting samples from the collections which meet a common range of acceptable metrics; and (c) rejecting sample groups or collections for comparisons showing association between the metric and the biological distinction targeted for biomarker discovery.

In a related embodiment, the invention provides a method for selecting a subset of samples suitable for biomarker discovery comprising: (a) calculating the quantitative metric for each sample: (i) for samples in a set intended for biomarker discovery, or (ii) from a plurality of collections of samples; (b) selecting from step (a): (i) samples of the set that meet acceptable ranges for quantitative metric, or (ii) samples from a subset of the collections which meet a common range of acceptable metrics; and (c) rejecting samples of step (a) showing association between the metric and the biological distinction targeted for biomarker discovery.

Further provided is a method for rejecting an entire collection comprising (a) selecting a subset of the samples, wherein the subset comprises all the samples of the collection or a random subset thereof; (b) calculating quantitative metric for each sample in the subset; (c) determining the proportion or distribution of samples that meet acceptable ranges for quantitative metric; and (d) determining whether to reject the collection. The rejection of the collection can be based upon (i) the distribution or proportion of acceptable samples; and/or (ii) the degree of the association between the clinical variation of interest and the quantitative metric.

The invention also provides a method of improving the quality of a sample comprising (a) separating a plasma supernatant from cells and cellular components of a sample of an individual; (b) freezing the plasma supernatant; (c) thawing the plasma supernatant; and (d) conducting a second spin of the thawed supernatant, whereby the sample of improved quality is produced. The spin is provided by a centrifuge spin for whole blood and/or the hard spin (hard spin is defined as a spin with a speed time product greater than 2500 g for 10 minutes.

Such a post thaw spin is useful in the context of a commercial service measuring many (more than 20) analytes per sample. Since in such a service the sample collection procedures may vary considerably across customer samples, and since the samples have previously been frozen and thawed, which lyses some cells, centrifuge spins at common clinically applied accelerations and times are ineffective in removing the smaller debris and contamination components.

In a further embodiment, the invention comprises a method of screening a sample or a sample set for its handling/processing marker values variability comprising (a) determining in said sample or sample set, handling/processing marker values that correspond to one of at least N markers selected from Table 1, wherein N=2-78; (b) providing a reference sample and determining the handling/processing marker values that correspond to the measured sample or sample set handling/processing markers; and (c) comparing the sample or sample set handling/processing marker values to corresponding handling/processing marker values of the reference sample, whereby the handling/processing marker value variability of the sample or sample set can be determined.

In related embodiments, the at least N markers are selected from Table 2, and N=2-30. Alternatively, the at least N markers are selected from Table 3, and N=2-52. Additional related embodiments include those in which the at least N markers are selected from Table 4, wherein N=2-17; and the at least N markers are selected from Table 5, and N=2-4.

Also provided is a method for determining the suitability of a sample or sample set for further analysis, additionally comprising: (a) providing the sample or sample set handling/processing marker value variability which has been obtained by the methods described hereinabove; and (b) determining from said variability whether the sample or sample set does not exceed predetermined cut-off values. In this way, the suitability of a sample or sample set is determined by the sample or sample set having handling/processing marker values that do not exceed the cut-off values.

In a related embodiment, the foregoing method of determining the suitability of a sample may include, before step (b), the following process steps: (a.1) obtaining the natural log value of each of the handling/processing marker values; and (a.2) weighting each of the natural log values according to a predetermined Sample Mapping Vector (SMV) coefficient to obtain a product for each of the handling/processing marker values of the sample or sample set. In this embodiment, the determination of whether the sample exceeds predetermined cut-off values in step (b), is accomplished by comparison of the sample's weighted product to the cut-off values.

In another embodiment, the invention comprises a method for determining a preferred sample handling and processing protocol, wherein the protocol generates samples suitable for further analysis. This method comprises providing a sample handling/processing variability as obtained by methods described herein, followed by: (a) determining, from said handling/processing marker value variability, markers that are sensitive to variations in the protocol procedures; and (b) varying protocol procedures to minimize the handling/processing marker value variability of the sensitive markers, whereby a preferred protocol can be determined.

The invention also comprises a method for determining compliance of a sample or sample set with predetermined collection protocol, comprising providing a sample handling/processing variability as obtained by methods described herein followed by: (a) providing a reference sample that has undergone the predetermined collection protocol; (b) determining from the reference sample, a cut-off value corresponding to each of said at least N markers; (c) comparing the handling/processing value of each sample or sample set with the corresponding cut-off value; (d) identifying the sample or sample set having handling/processing value variability that exceeds the cut-off values and the sample or sample set that does not exceed the cut-off values, wherein the sample or sample set whose variability does not exceed the cut-off value is in compliance with the predetermined collection protocol.

Also provided is a method for identification of at least one reliable biomarker comprising: (a) providing the sample or sample set suitable for further analysis obtained by methods described herein, wherein each the sample or sample set is known to be obtained from a diseased individual or a non-diseased individual; (b) assaying the sample or sample set to identify the at least one reliable biomarker, wherein the biomarker is substantially differentially expressed in samples or sample sets from the diseased individual relative to corresponding markers in samples or sample sets from individuals who are not diseased. Markers identified as being differentially expressed in diseased individuals relative to non-diseased individuals are reliable biomarkers.

In another embodiment, the invention comprises a method for determining a robust biomarker using a sample suitable for further analysis as obtained by methods described herein. This method comprises: (a) providing the suitable samples or sample sets from diseased individuals and from non-diseased individuals; (b) identifying biomarkers that are not detected in substantially all of the samples or sample sets from diseased individuals; (c) identifying as robust biomarkers, the biomarkers that are detected in substantially all of the samples or sample sets from diseased individuals.

The invention further provides a method for determining a sample quality standard comprising a normal range or preferred cut-off values, for identification of a sample or sample set that is suitable for further analysis. This method comprises: (a) providing at least one control sample; (b) determining sample/handling marker value variability in the control sample according to methods described herein; (c) determining the handling/processing markers that are sensitive to variations in sample handling and processing protocol; (d) defining for each of the sample handling/processing markers that is sensitive to protocol variations, a normal range and preferred cut-off values for each said handling/processing marker. This provides the sample quality standard or preferred cut-off values, and samples or sample sets can be screened using the preferred cut-off values to identify a suitable sample or sample set.

In another embodiment, the invention comprises the determination of bias of a sample handling/processing marker in a sample or sample set. This method comprises: (a) identifying in the suitable samples or sample sets provided according methods provided herein, sample handling/processing markers that are sensitive to variations in sample collection and handling protocol; (b) providing a reference or control sample; (c) measuring said sensitive sample handling/processing marker values in the suitable samples or sample sets and in the reference sample; (d) comparing the measured sample or sample set handling/processing marker values to the reference sample handling/processing marker values; (e) identifying handling/processing marker values of the sample or sample set that vary from the reference sample handling/processing marker value; and (f) distinguishing in the handling/processing markers having value variation from said reference marker value, the sample handling/processing markers that mimic disease biomarker value variation. The distinguished handling/processing markers that mimic disease biomarkers are biased handling/processing markers. These biased handling/processing markers can be eliminated from further analysis.

Also provided is a method for correcting the measured biomarker value of a sample, comprising: (a) measuring the handling/processing marker value variability of the sample as provided by methods described herein; (b) identifying a change in handling/processing marker values of the sample relative to the handling/processing marker values of a reference; and (c) correcting the sample's biomarker measurement in accordance with the identified change in handling/processing marker values of the sample relative to the handling/processing values of the reference sample.

### EXAMPLES

The following examples are provided for illustrative purposes only and are not intended to limit the scope of the application as defined by the appended claims. All examples described herein were carried out using standard techniques, which are well known and routine to those of skill in the art. Routine molecular biology techniques described in the following examples can be carried out as described in standard laboratory manuals, such as Sambrook et al., Molecular Cloning: A Laboratory Manual, 3rd. ed., Cold Spring Harbor Laboratory Press, Cold Spring Harbor, N.Y., (2001).

### Example 1

### Multiplexed Aptamer Analysis of Samples

This example describes the multiplex aptamer assay used to analyze the samples and controls for the identification of the sample collection/processing variability markers set forth in Table 1. The multiplexed analysis utilized either approximately 850 or 1,034 aptamers, depending on the version of the proteomics array used to generate the data. Details of this proteomic platform can be found in Gold L, Ayers D, Bertino J, Bock C, Bock A, et al. (2010) Aptamer-Based Multiplexed Proteomic Technology for Biomarker Discovery. PLoS ONE 5(12):e15004. doi:10.1371/journal.pone.0015004.

In this method, pipette tips were changed for each solution addition.

Also, unless otherwise indicated, most solution transfers and wash additions used the 96-well head of a Beckman Biomek FxP. Method steps manually pipetted used a twelve channel P200 Pipetteman (Rainin Instruments, LLC, Oakland, Calif.), unless otherwise indicated. A custom buffer referred to as SB17 was prepared in-house, comprising 40 mM HEPES, 100 mM NaCl, 5 mM KCl, 5 mM MgCl2, 1 mM EDTA at pH 7.5. A custom buffer referred to as SB18 was prepared in-house, comprising 40 mM HEPES, 100 mM NaCl, 5 mM KCl, 5 mM MgCl₂ at pH 7.5. All steps were performed at room temperature unless otherwise indicated.

1. Preparation of Aptamer Stock Solution

Custom stock aptamer solutions for 5%, 0.316% and 0.01% serum were prepared at 2× concentration in 1×SB17, 0.05% Tween-20.

These solutions are stored at −20° C. until use. The day of the assay, each aptamer mix was thawed at 37° C. for 10 minutes, placed in a boiling water bath for 10 minutes and allowed to cool to 25° C. for 20 minutes with vigorous mixing in between each heating step. After heat-cool, 55 μl of each 2× aptamer mix was manually pipetted into a 96-well Hybaid plate and the plate foil sealed. The final result was three, 96-well, foil-sealed Hybaid plates with 5%, 0.316% or 0.01% aptamer mixes. The individual aptamer concentration was 2× final or 1 nM.

2. Assay Sample Preparation

Frozen aliquots of 100% serum or plasma, stored at −80° C., were placed in 25° C. water bath for 10 minutes. Thawed samples were placed on ice, gently vortexed (set on 4) for 8 seconds and then replaced on ice.

A 10% sample solution (2× final) was prepared by transferring 8 μL of sample using a 50 μL 8-channel spanning pipettor into 96-well Hybaid plates, each well containing 72 μL of the appropriate sample diluent at 4° C. (1×SB17 for serum or 0.8×SB18 for plasma, plus 0.06% Tween-20, 11.1 μM Z-block_{—}2, 0.44 mM MgCl₂, 2.2 mM AEBSF, 1.1 mM EGTA, 55.6 uM EDTA for serum). This plate was stored on ice until the next sample dilution steps were initiated on the Biomek FxP robot.

To commence sample and aptamer equilibration, the 10% sample plate was briefly centrifuged and placed on the Biomek FxP where it was mixed by pipetting up and down with the 96-well pipettor. A −0.632% sample plate (2× final) was then prepared by transferring 6 μL of the 10% sample plate into 89 μL of 1×SB17, 0.05% Tween-20 with 2 mM AEBSF. Next, dilution of 6 μL of the resultant 0.632% sample into 184 μL of 1×SB17, 0.05% Tween-20, made a 0.02% sample plate (2× final). Dilutions were done on the Beckman Biomek FxP. After each transfer, the solutions were mixed by pipetting up and down. The 3 sample dilution plates were then transferred to their respective aptamer solutions by adding 55 μL of the sample to 55 μL of the appropriate 2× aptamer mix. The sample and aptamer solutions were mixed on the robot by pipetting up and down.

3. Sample Equilibration Binding

The sample/aptamer plates were sealed with silicon cap mats and placed into a 37° C. incubator for 3.5 hours before proceeding to the Catch 1 step.

4. Preparation of Catch 2 Bead Plate

An 11 mL aliquot of MyOne (Invitrogen Corp., Carlsbad, Calif.) Streptavidin C1 beads was washed 2 times with equal volumes of 20 mM NaOH (5 minute incubation for each wash), 3 times with equal volumes of 1×SB17, 0.05% Tween-20 and resuspended in 11 mL 1×SB17, 0.05% Tween-20. Using a 12-channel pipettor, 50 μL of this solution was manually pipetted into each well of a 96-well Hybaid plate. The plate was then covered with foil and stored at 4° C. for use in the assay.

5. Preparation of Catch 1 Bead Plates

Three 0.45 μm Millipore HV plates (Durapore membrane, Cat# MAHVN4550) were equilibrated with 100 μL of 1×SB17, 0.05% Tween-20 for at least 10 minutes. The equilibration buffer was then filtered through the plate and 133.3 μL of a 7.5% Streptavidin-agarose bead slurry (in 1×SB17, 0.05% Tween-20) was added into each well. To keep the streptavidin-agarose beads suspended while transferring them into the filter plate, the bead solution was manually mixed with a 200 μL, 12-channel pipettor, at least 6 times between pipetting events. After the beads were distributed across the 3 filter plates, a vacuum was applied to remove the bead supernatant. Finally, the beads were washed in the filter plates with 200 μL 1×SB17, 0.05% Tween-20 and then resuspended in 200 μL 1×SB17, 0.05% Tween-20. The bottoms of the filter plates were blotted and the plates stored for use in the assay.

6. Loading the Cytomat

The Cytomat was loaded with all tips, plates, all reagents in troughs (except NHS-biotin reagent which was prepared fresh right before addition to the plates), 3 prepared catch 1 filter plates and 1 prepared MyOne plate.

7. Catch 1

After a 3.5 hour equilibration time, the sample/aptamer plates were removed from the incubator, centrifuged for about 1 minute, cap mat covers removed, and placed on the deck of the Beckman Biomek FxP. The Beckman Biomek FxP program was initiated. All subsequent steps in Catch 1 were performed by the Beckman Biomek FxP robot unless otherwise noted. Within the program, the vacuum was applied to the Catch 1 filter plates to remove the bead supernatant. One hundred microlitres of each of the 5%, 0.316% and 0.01% equilibration binding reactions were added to their respective Catch 1 filtration plates, and each plate was mixed using an on-deck orbital shaker at 800 rpm for 10 minutes.

Unbound solution was removed via vacuum filtration. The Catch 1 beads were washed with 190 μL of 100 μM biotin in 1×SB17, 0.05% Tween-20 followed by 5×190 μL of 1×SB17, 0.05% Tween-20 by dispensing the solution and immediately drawing a vacuum to filter the solution through the plate.

8. Tagging

A 100 mM NHS-PEO4-biotin aliquot in anhydrous DMSO (stored at −20° C.) was thawed at 37° C. for 6 minutes and then was diluted 1:100 with tagging buffer (SB17 at pH=7.25, 0.05% Tween-20), immediately before manual addition to an on-deck trough whereby the robot dispensed 100 μL of the NHS-PEO4-biotin into each well of each Catch 1 filter plate. This solution was allowed to incubate with Catch 1 beads shaking at 800 rpm for 5 minutes on the orbital shakers.

9. Kinetic Challenge and Photo-Cleavage

The tagging reaction was removed by vacuum filtration and the reaction quenched by the addition of 150 μL of 20 mM glycine in 1×SB17, 0.05% Tween-20 to the Catch 1 plates. The glycine solution was removed via vacuum filtration and another 1500 μL of 20 mM glycine (in 1×SB17, 0.05% Tween-20) was added to each plate and incubated for 1 minute on orbital shakers at 800 rpm before removal by vacuum filtration.

The wells of the Catch 1 plates were subsequently washed by adding 190 μL 1×SB17, 0.05% Tween-20, followed immediately by vacuum filtration and then by adding 190 μL 1×SB17, 0.05% Tween-20 with shaking for 1 minute at 800 rpm before vacuum filtration. These two wash steps were repeated two more times with the exception that the last wash was not removed by vacuum filtration. After the last wash the plates were placed on top of a 1 mL deep-well plate and removed from the deck for centrifugation at 1000 rpm for 1 minute to remove as much extraneous volume from the agarose beads before elution as possible.

The plates were placed back onto the Beckman Biomek FxP and 85 μL of 10 mM DxSO4 in 1×SB17, 0.05% Tween-20 was added to each well of the filter plates.

The filter plates were removed from the deck, placed onto a Variomag Thermoshaker (Thermo Fisher Scientific, Inc., Waltham, Mass.) under the BlackRay (Ted Pella, Inc., Redding, Calif.) light sources, and irradiated for 5 minutes while shaking at 800 rpm. After the 5-minute incubation the plates were rotated 180 degrees and irradiated with shaking for 5 minutes more.

The photocleaved solutions were sequentially eluted from each Catch 1 plate into a common deep well plate by first placing the 5% Catch 1 filter plate on top of a 1 mL deep-well plate and centrifuging at 1000 rpm for 1 minute. The 0.316% and 0.01% Catch 1 plates were then sequentially centrifuged into the same deep well plate.

10. Catch 2 Bead Capture

The 1 mL deep well block containing the combined eluates of Catch 1 was placed on the deck of the Beckman Biomek FxP for Catch 2.

The robot transferred all of the photo-cleaved eluate from the 1 mL deep-well plate onto the Hybaid plate containing the previously prepared Catch 2 MyOne magnetic beads (after removal of the MyOne buffer via magnetic separation).

The solution was incubated while shaking at 1350 rpm for 5 minutes at 25° C. on a Variomag Thermoshaker (Thermo Fisher Scientific, Inc., Waltham, Mass.).

The robot transferred the plate to the on deck magnetic separator station. The plate was incubated on the magnet for 90 seconds before removal and discarding of the supernatant.

11. 37° C. 30% Glycerol Washes

The Catch 2 plate was moved to the on-deck thermal shaker and 75 μL of 1×SB17, 0.05% Tween-20 was transferred to each well. The plate was mixed for 1 minute at 1350 rpm and 37° C. to resuspend and warm the beads. To each well of the catch 2 plate, 75 μL of 60% glycerol at 37° C. was transferred and the plate continued to mix for another minute at 1350 rpm and 3° C. The robot transferred the plate to the 37° C. magnetic separator where it was incubated on the magnet for 2 minutes and then the robot removed and discarded the supernatant. These washes were repeated two more times.

After removal of the third 30% glycerol wash from the Catch 2 beads, 150 μL of 1×SB17, 0.05% Tween-20 was added to each well and incubated at 37° C., shaking at 1350 rpm for 1 minute, before removal by magnetic separation on the 37° C. magnet.

The Catch 2 beads were washed a final time using 150 μL 1×SB19, 0.05% Tween-20 with incubation for 1 minute while shaking at 1350 rpm, prior to magnetic separation.

12. Catch 2 Bead Elution and Neutralization

The aptamers were eluted from Catch 2 beads by adding 105 μL of 100 mM CAPSO with 1M NaCl, 0.05% Tween-20 to each well. The beads were incubated with this solution with shaking at 1300 rpm for 5 minutes.

The Catch 2 plate was then placed onto the magnetic separator for 90 seconds prior to transferring 63 μL of the eluate to a new 96-well plate containing 7 μL of 500 mM HCl, 500 mM HEPES, 0.05% Tween-20 in each well. After transfer, the solution was mixed robotically by pipetting 60 μL up and down five times.

13. Hybridization

The Beckman Biomek FxP transferred 20 μL of the neutralized Catch 2 eluate to a fresh Hybaid plate, and 6 μL of 10× Agilent Block, containing a 10× spike of hybridization controls, was added to each well. Next, 30 μL of 2× Agilent Hybridization buffer was manually pipetted to each well of the plate containing the neutralized samples and blocking buffer and the solution was mixed by manually pipetting 25 μL up and down 15 times slowly to avoid extensive bubble formation. The plate was spun at 1000 rpm for 1 minute.

Custom Agilent microarray slides (Agilent Technologies, Inc., Santa Clara, Calif.) were designed to contain probes complementary to the aptamer random region plus some primer region. For the majority of the aptamers, the optimal length of the complementary sequence was empirically determined and ranged between 40-50 nucleotides. For later aptamers a 46-mer complementary region was chosen by default. The probes were linked to the slide surface with a poly-T linker for a total probe length of 60 nucleotides.

A gasket slide was placed into an Agilent hybridization chamber and 40 μL of each of the samples containing hybridization and blocking solution was manually pipetted into each gasket. An 8-channel variable spanning pipettor was used in a manner intended to minimize bubble formation. The custom Agilent slides, with the barcode facing up, were then slowly lowered onto the gasket slides (see Agilent manual for detailed description).

The top of the hybridization chambers were placed onto the slide/backing sandwich and clamping brackets slid over the whole assembly. These assemblies were tightly clamped by turning the screws securely.

Each slide/backing slide sandwich was visually inspected to assure the solution bubble could move freely within the sample. If the bubble did not move freely, the hybridization chamber assembly was gently tapped to disengage bubbles lodged near the gasket.

The assembled hybridization chambers were incubated in an Agilent hybridization oven for 19 hours at 60° C. rotating at 20 rpm.

14. Post Hybridization Washing

Approximately 400 mL Agilent Wash Buffer 1 was placed into each of two separate glass staining dishes. One of the staining dishes was placed on a magnetic stir plate and a slide rack and stir bar were placed into the buffer.

A staining dish for Agilent Wash 2 was prepared by placing a stir bar into an empty glass staining dish.

A fourth glass staining dish was set aside for the final acetonitrile wash.

Each of six hybridization chambers was disassembled. One-by-one, the slide/backing sandwich was removed from its hybridization chamber and submerged into the staining dish containing Wash 1. The slide/backing sandwich was pried apart using a pair of tweezers, while still submerging the microarray slide. The slide was quickly transferred into the slide rack in the Wash 1 staining dish on the magnetic stir plate.

The slide rack was gently raised and lowered 5 times. The magnetic stirrer was turned on at a low setting and the slides incubated for 5 minutes.

When one minute was remaining for Wash 1, Wash Buffer 2 pre-warmed to 37° C. in an incubator was added to the second prepared staining dish. The slide rack was quickly transferred to Wash Buffer 2 and any excess buffer on the bottom of the rack was removed by scraping it on the top of the stain dish. The slide rack was gently raised and lowered 5 times. The magnetic stirrer was turned on at a low setting and the slides incubated for 5 minutes. The slide rack was slowly pulled out of Wash 2, taking approximately 15 seconds to remove the slides from the solution.

With one minute remaining in Wash 2 acetonitrile (ACN) was added to the fourth staining dish. The slide rack was transferred to the ACN stain dish. The slide rack was gently raised and lowered 5 times. The magnetic stirrer was turned on at a low setting and the slides incubated for 5 minutes.

The slide rack was slowly pulled out of the ACN stain dish and placed on an absorbent towel. The bottom edges of the slides were quickly dried and the slide was placed into a clean slide box.

15. Microarray Imaging

The microarray slides were placed into Agilent scanner slide holders and loaded into the Agilent Microarray scanner according to the manufacturer's instructions.

The slides were imaged in the Cy3-channel at 5 μm resolution at the 100% PMT setting and the XRD option enabled at 0.05. The resulting tiff images were processed using Agilent feature extraction software version 10.5.

### Example 2

### Sample Handling/Processing Marker Identification and Derivation of Sample Handling Metrics

Numerous differences were observed between blood samples from clinical study participants collected from different clinical sites. This site-dependence of aptamer signals associated with sample handling/processing markers was hypothesized to be a direct result of the sample collection protocol used. Strong differences were observed in sample handling and processing markers between sites that used the preferred protocol. To better understand the effect of different sample collection and processing procedures, a series of in-house experiments were performed where the collection parameters were varied. These experiments revealed that perturbations to sample collection protocols result in changes to many proteins in a coordinated fashion. As a result of these experiments, the sample handling and processing marker protein signatures associated with particular methods of sample collection and processing are more completely understood and it is now possible to measure how well a single sample has been collected and processed. Table 1 lists the sample handling/processing markers associated with serum or plasma cell lysis/contamination (referred to as “cell abuse”), platelet contamination, and complement activation. Thus, the markers of Table 1 can serve as sample handling and processing markers. The foregoing information provides a sample quality value which can be used to adjust the measured biomarker values in a case sample.

The identification of biomarkers that are sensitive to clinical sample collection can be identified by intentionally perturbing a specific step in sample collection. Some examples include the speed at which a sample is centrifuged, the time elapsed before a sample is centrifuged, the time elapsed before sample is frozen, and the type of needle used to draw the sample. Many of these clinical steps are ways in which two different collection sites may differ in their sample preparation, which can lead to biases between collections. Often these differences result in reducing the quality of a sample (e.g., contamination or degradation). By reproducing these differences, analytes likely to affected by these biases can be identified, and ultimately used to quantify the negative effect of deviations from a proper collection protocol.

Once a large set of affected analytes is identified, the list should be reduced to a sparse set of analytes that are believed to be related to a single biological source, whether that is a biological pathway or a biological component, such as a cell. This can be accomplished by looking at the covariation of the analytes to identify a sparse set that doesn't share much covariance with other analytes. Once this set of analytes is refined, incorporating prior knowledge about the function of these analytes may shed light on their biological cause. For example, if all the analytes come from the same cell type, it suggests they are present in the sample because those cells have lysed.

With a sparse set of analytes identified, these analytes can be incorporated into a quantitative model which would measure the extend of the particular abuse to the sample caused by deviations from proper sample collection. This model can be linear or non-linear in nature. Alternatively, qualitative models can also be trained that would return the classification of the sample rather than a quantitative measurement. This model could be used to triage samples into various levels of sample quality.

Finally, targeted biochemical experiments can be performed to attempt to reproduce the effect and hopefully shed light on the underlying biological processes which dictate the observed analyte signature. For example, if the analytes in the model are enriched for proteins known to be involved in platelet activation, then a biochemical experiment which intentionally activates platelets can be performed to test whether the model accurately measures the degree of activation. This provides support for the validity of the model as well as the proposed biological source of the variation.

### Exemplary Quantitative Model

One possibility for a quantitative model to measure sample handling differences is a linear model where each analyte receives a coefficient. These coefficients can be trained in a supervised or un-supervised fashion. In a supervised training, a response variable is provided and the coefficients are trained to minimize the error between the linear model and the response. In an un-supervised training, no response is provided, and the coefficients are selected via the covariance structure in the data. The following exemplary model was trained in an unsupervised fashion using the loadings from Principal Components Analysis (PCA). It will be used to quantify sample handling effects in the following examples, but only represents one single possible method for measuring these effects.

The coefficients that were derived for each marker protein using PCA are listed in Table 1. The coefficient lists are known as “Sample Mapping Vectors” (SMVs). The commonly applied SMVs are listed in Tables 2 to 5. As knowledge of pre-analytic sample variability grows, it is feasible that new vectors will be defined. Table 2 lists the handling/processing marker proteins and weights for the SMV that measure the degree of lysis in blood cells for blood serum samples. Table 3 lists the handling/processing marker proteins and SMV weights measuring the degree of blood cell lysis in blood plasma samples. Table 4 lists the handling/processing marker proteins and SMV weights measuring platelet activation in blood plasma samples. Table 5 lists the SMV for handling/processing proteins associated with activation of the innate immune response blood complement system. The SMVs in Tables 2-5 are used to evaluate a sample by calculating the magnitude of the sample along the direction of the Sample Mapping Vector, which is done by performing the dot product of the protein measurements that define the SMV and the corresponding handling/processing protein measurements in the sample. These markers can be assembled into a quantitative assessment of sample quality and applied to unknown samples to assess sample integrity.

These vectors are applied to an individual sample with the following procedure:

1. Take the natural logarithm of sample handling/processing marker protein measurements in the given sample.

2. For each sample handling/processing marker protein, multiply the corresponding log measurement from step 1 by the corresponding SMV weight.

3. Sum the resulting products of step 2 to form the sample quality result.

The use of the logarithmic transformation in the procedure above allows for the determination of proportional change relative to a reference. Each case sample assay was compared to the standard reference sample, thereby permitting the relative changes across sample sets and assay versions without complication. This is similar to the common use of “log ratio” measurements in gene expression studies.

Below is a formal description of how an SMV is applied to a given sample to calculate an SMV score. Let S be an SMV of m proteins composed of coefficients sᵢ, i 1, . . . , n. Let X be a given sample with p protein measurements in logₑ RFU units, where xⱼ represents the j^{th} protein measurement. Since the proteins that define S and the measured proteins in X may not be the same set, X* and S* are defined as the subset of X and S respectively that correspond to the common set of n proteins between X and S. Finally, the SMV score, C, is defined as the dot product of X* and S*:

$$C = {\sum }_{k = 1}^{n} {s}_{k}^{*} {x}_{k}^{*}$$

### Example 3

### Time-to-Spin Experiments

One of the first in-house sample handling experiments was published in 2010 and measured protein concentrations in blood after varying the time-to-spin and time-to-freeze of sample collection (Ostroff, R. et al. (2010) J. Proteomics 73:649-666). These samples were collected in 3 different tube types and spun for 15 minutes at 1300 g. For each of the four individuals per tube type in the study the time-to-spin values were a half hour, hour, two hours, four hours, and twenty hours; and the time-to-freeze values were a half hour, two hours, six hours, and twenty hours. All combinations of these time-to-spin and time-to-freeze experiments supplied twenty samples for each individual for each tube type. Since that publication, techniques have been developed for assessing the degree to which samples have been abused, largely using variations of Principal Components Analysis (PCA). PCA is a dimensionality reduction technique that identifies samples that contain analytes that vary in a concerted fashion. By looking at the PCA rotation matrix (analyte space) and the PCA projection matrix (sample space), the directions of variation in the data can easily be identified.

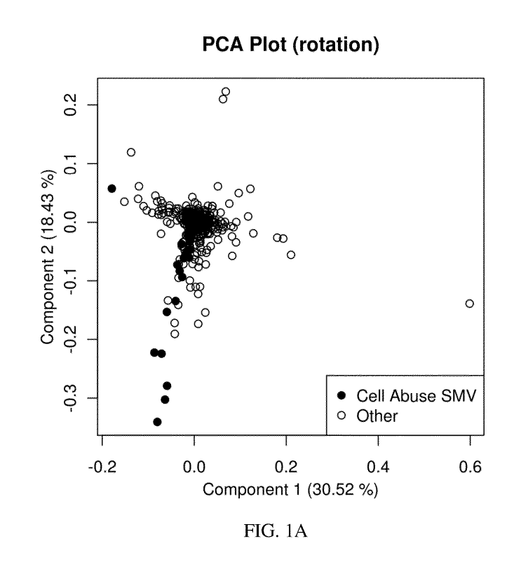

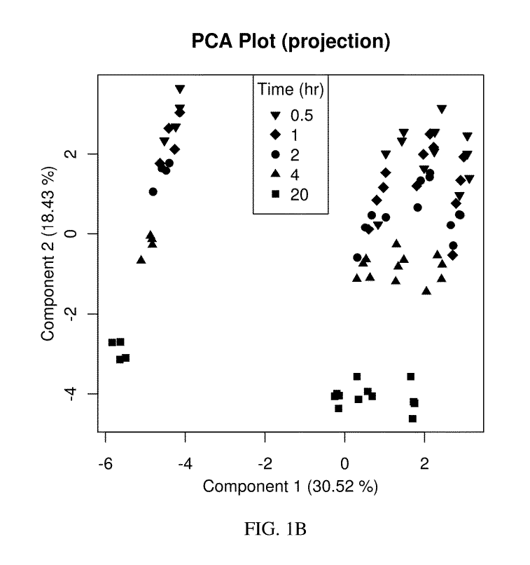

FIG. 1 demonstrates the retrospective application of the newly discovered sample mapping vector approach to the previously published time-to-spin and time-to-freeze experiment. FIG. 1A shows a plot of the first two components (columns) of the rotation matrix and FIG. 1B shows the corresponding first two components of the projection matrix. FIG. 1B shows that the samples are divided on both axes. The first component (x-axis) separates the samples into four vertical groups, which correspond to the four individuals in the study. Looking at the first component in the rotation plot (analyte space), the analytes that underlie this variance between individuals are separated from the main cluster of points. Two of these analyst are Follicle Stimulating Hormone and Luteinizing Hormone, both of which are known to vary between males and females and between individuals. These two analytes are part of a classifier that permits one to distinguish between men and women even in blinded sample sets.

The analytes that are affected by the time to spin have large negative coefficients on component 2 (vertical axis). The samples in FIG. 1B have been given different symbols for each time-to-spin value. The analytes from the serum Cell Abuse SMV in FIG. 1A have been highlighted using solid circles

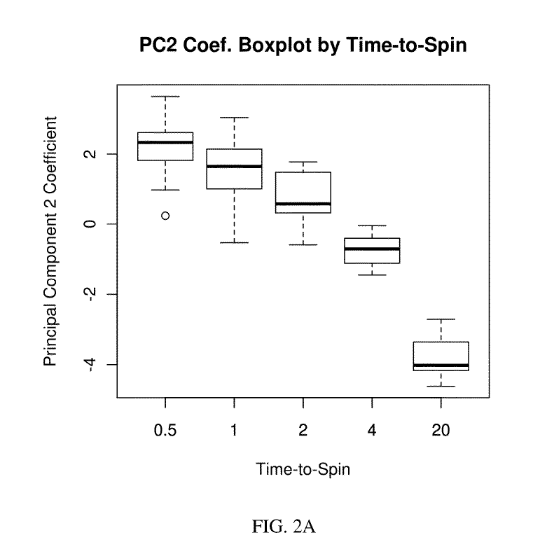

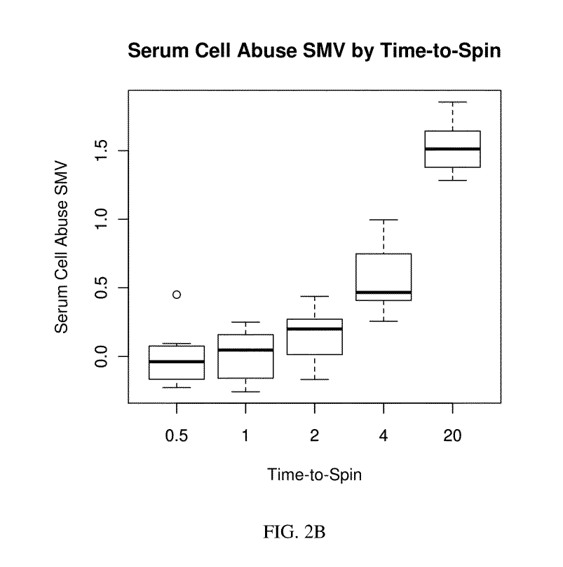

The relative position of a sample on component 2 indicates the magnitude of the cellular contamination protein signature in that sample. FIG. 2A shows a boxplot of these coefficients grouped by time-to-spin. The progression of this analyte signature with time is clearly shown in this figure. This same progression can be observed in the serum Cell Abuse SMV. The fact that the progression is in opposite direction is merely a consequence of PCA assigning arbitrary signs to coefficients. The important observation is that the trained Cell Abuse SMV measures the same protein signature identified via PCA.

### Example 4

### Sample Handling in Retrospective Study Collections

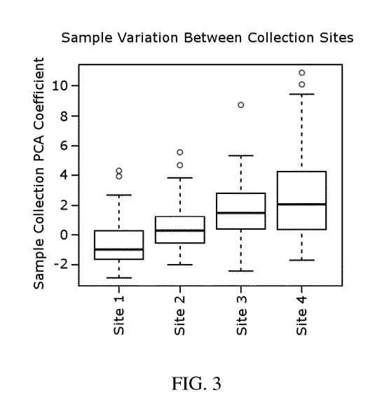

Using the methods described above we can identify samples and collection sites which adhere to strict collection protocols and which do not. FIG. 3 shows the boxplot of the PCA coefficient associated with sample collection in a multi-center retrospective clinical study. Each site differs in the magnitude and variability range of PCA coefficient on the principal component associated with sample collection differences. This serves as an example of how PCA can be used as a tool to assess the quality of the sample processing at a given site.

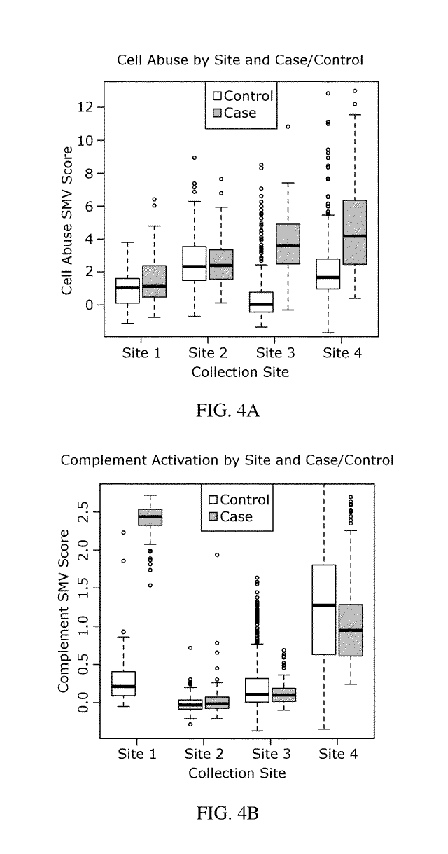

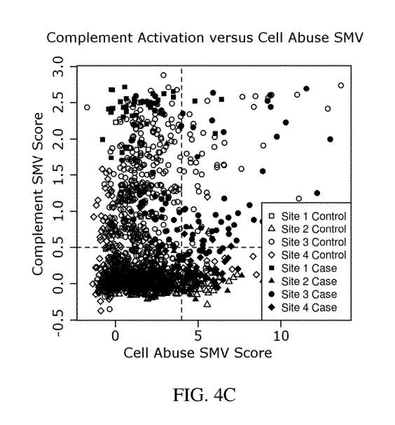

FIG. 4 shows a serum sample set mapped using the Complement SMV and serum Cell Abuse SMV for each sample. In this large sample set, blood samples from cancer patients and non-disease controls come from multiple institutional sites. FIG. 4A is a boxplot showing the case control difference between Cell Abuse SMV stratified by collection site. This plot reveals differences between both sites and between case and control within a site. FIG. 4B is a boxplot with the same stratification showing the Complement Activation SMV. This plot shows a different set of biases between case and control and between sites.

FIG. 4C is a scatter plot of the Complement SMV versus the Cell Abuse SMV score. The full vs. open symbol difference corresponds to the cancer case result vs. the control result obtained when case and control individuals are assayed for biomarker discovery. The dotted lines represent an example of an imposed threshold for quality sample collection. The vertical line denotes the complement activation SMV limit of acceptance samples. To the right of this line is a level of complement activation which interferes with the ability to detect biomarkers. The horizontal line denotes the Serum Cell Abuse SMV limit, illustrating samples which were probably not processed within 2 hours or were not properly spun are above the line. It can be seen that the Complement SMV and Serum Cell Abuse SMV acceptability limits are somewhat independent, and that therefore both the serum cell lysis and complement activation criteria must be applied. In addition, it can be seen that the filled squares lie isolated at the top of the plot whereas the open squares are in the concentrated ball of points in the bottom left. This indicates that the collection site samples are not collected in a uniform manner between cancer cases and controls, and therefore samples from this site may be removed from consideration.

### Example 5

### Application of SMV to Evaluate Individual Samples and Sample Collections

The SomaLogic Healthy Normal study (SHN) investigated the effect different sample collection protocols on the blood protein measurements. Nine samples were collected from ten individuals using three different collection protocols and three different tube types. All tubes had an initial spin of 2500 g for 20 minutes. All tubes not on the 2-hour preferred protocol (aliquoted and frozen within 2 hours) were spun again at 1850 g for 10 min and then 2500 g for 20 min before processing at either 24 hours or 48 hours of 4 C storage. The three protocols are:
2-hour (Preferred Protocol): Spun, separated and frozen within 2 hours of collection
24-hour refrigeration period prior to aliquoting and freezing
48-hour refrigeration period prior to aliquoting and freezing

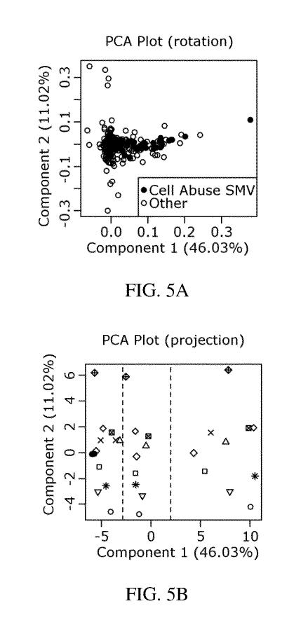

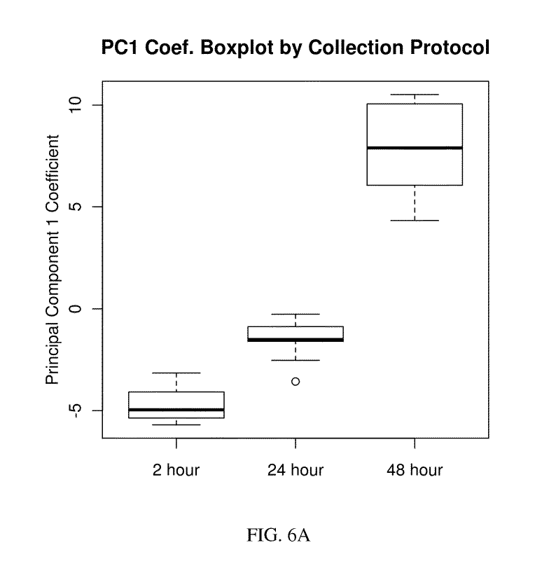

For each protocol, blood was collected using three tube types: EDTA plasma tubes, plasma P100 tubes, and serum SST tubes. The plasma P100 tube differs from the standard EDTA plasma tubes in that it contains protease inhibitors as well as a mechanical separator that filters larger components such as cells and platelets using a physical barrier. The serum SST tubes also contain a barrier, however the barrier is composed of a polyester based gel. PCA analysis of the EDTA tubes clusters the samples very nicely into three separate groups corresponding to the three different collection protocols (FIG. 5). With each run of the assay control samples called Calibrators have been included which are run in triplicate using the preferred protocol. These samples, shown as solid circles in FIG. 5B are the least affected cluster. The next two successive column-wise clusters are the 24-hour and the 48-hour protocols respectively.

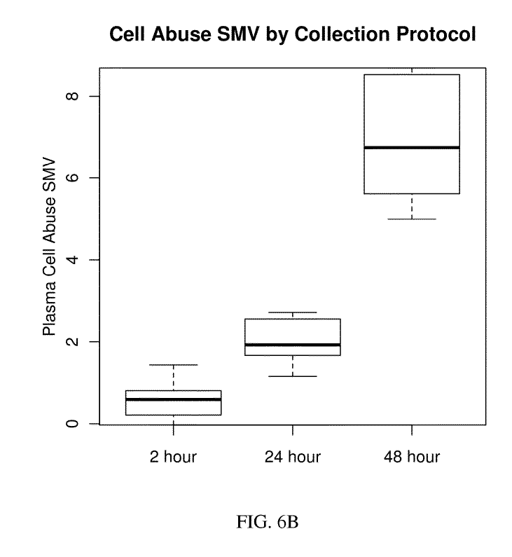

FIG. 6 shows a comparison of the PCA coefficients from principal component 1 (FIG. 5B) and the plasma Cell Abuse SMV scores for the same set of samples. These two boxplots show that the Cell Abuse SMV correctly measures the increase in cellular abuse as the samples are left unspun for increasing amounts of time.

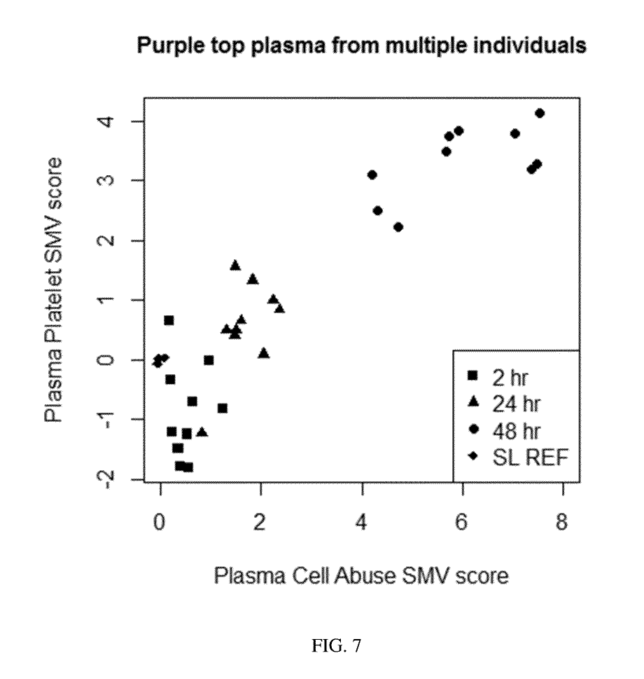

In FIG. 7 the Plasma Platelet SMV measurement is plotted against Plasma Cell Abuse SMV measurement for the samples in the SHN Study. A single experimental variable (time before centrifuging the sample) was varied. In this case, Plasma Platelet SMV and Plasma Abuse SMV both increased with the time between venipuncture and plasma separation by centrifugation. Both SMV measurements were affected in a similar way by the time to centrifugation in the SHN study.

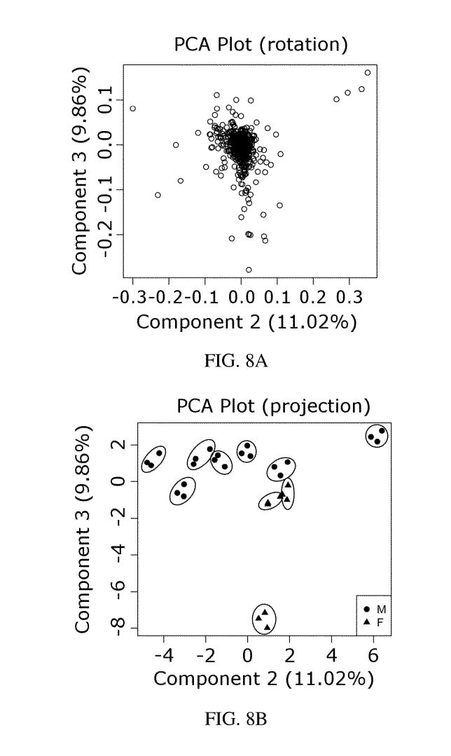

As observed in the time-to-spin and time-to-freeze experiment, in addition to the sample collection component there is also population component that separates the individuals in the study. This can be seen in FIG. 5 on the second component, which separates the three dots of the same color into rows. Plotting with components 2 and 3 eliminates or reduces the effects of sample handling. In FIG. 8, removal of the sample handling effects enables the true biological variation in the population to become much more obvious—the biomarker signals become more reliable. This is demonstrated in two ways. First, the three points from the same individuals now cluster together in a way that was not obvious in FIG. 7 (indicated by circling dots from same individual in FIG. 8B); the biology within the same individuals when sampled at the same time is likely to be more similar than biology between individuals. Second, gender differences are now revealed in these samples: the points that are clearly separated at the bottom of the plot correspond to the post-menopausal female in the study, who as expected, has extremely elevated LH and FSH values as discussed above. The other two females also have higher levels relative to the male population. There is also a single male that has the PCA coefficient as high as the females, however, this is due to the other analytes that are not gender-related that happen to be correlated with LH and FSH. Thus, biomarkers of two expected biological effects (consistency within subjects and gender) are revealed or improved by this process.

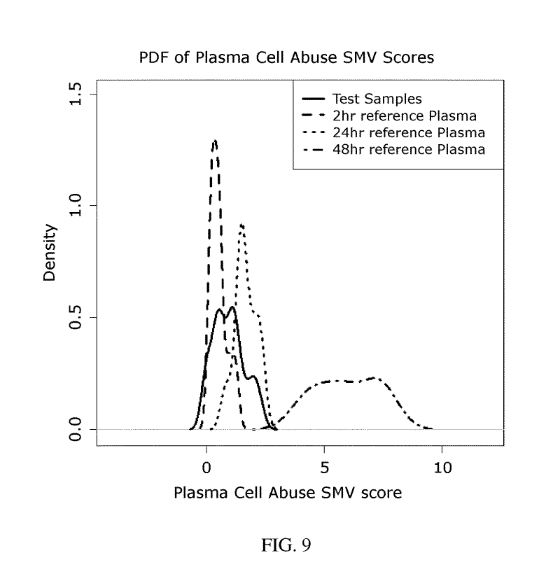

FIG. 9 demonstrates application of the Plasma Cell Abuse SMV to compare a sample set of unknown quality, the Test Set, to reference samples of known preparation time from the SHN study. It shows the distribution of the Plasma Cell Abuse SMV measurements for the Test Set samples. The measurements are seen to be equivalent in terms of the Plasma Cell Abuse SMV to the SHN reference samples collected within 24 hours, and thus could be accepted for biomarker discovery purposes. This permits the screening of selections of samples from a collection prior to assaying large numbers of samples, hence saving time and effort over running all the samples in a collection. The Test Set sample distribution has a multi-modal distribution, indicating that there may have been collection differences within the single site. Only the samples of poorest quality, which form the right-most peak, could be removed rather than accepting or rejecting the entire set or collection.

### Example 6

### Collection Tube Comparison

To determine how many analytes were significantly affected by the different collection protocols, a series of Mann-Whitney (MW) Rank Sum tests were performed. The MW test is a non-parametric test that evaluates whether one sample set is greater or less than another sample set. For each analyte, the concentrations measured for each individual were assessed to determine if they differed according to the collection protocol. The 2-hour protocol was tested against both the 24-hour collection and the 48-hour collection protocols.

Table 6 shows the number of analytes which significantly increased or decreased in value in the SHN protocol out of the total 868 analytes measured in that study. The threshold for significance in this table was an FDR-corrected p-value (q-value) of less than 0.05. At this threshold, the P100 Plasma tubes were the least affected for the 24-hour protocol with only four affected analytes. The SST tubes were second with seventeen and the standard EDTA plasma tubes had thirty-seven affected analytes. This supports what the observation in the PCA analysis, that the mechanical barrier of the P100 tubes is more effective than the gel barrier of the SST serum tubes. Most of the analytes for these three tubes increase, which is consistent with cellular contamination

When the 48-hour collection protocol is used, the number of significantly affected analytes increases dramatically. Interestingly, the number of affected analytes in the P100 tubes surpasses the number of affected analytes in the SST serum tubes. This is most likely because the serum samples have already been clotted; processes like platelet and complement activation have already run close to completion, thus minimizing the possibility for differential expression. Another interesting observation is that the proportion of analytes that decreased relative to the 2-hour protocol has increased as well. This could be due to proteolysis in the sample over the 48-hour refrigeration. The dramatic increase in analytes that significantly increase in the 48 hour protocol could be due to proteins slowly diffusing back through the filter.

### Example 7

### Experimental Validation of Cell Abuse SMV Via Shear

Fourteen samples were obtained by venipuncture using a 21 gauge needle appended to a purple-top Vacutainer (plasma) or tiger-top Vacutainer (serum). Samples were immediately sheared via either 0, 2, 3, 4, 6, 8, or 10 passages through a 21½ gauge needle at approximately 100 ml/minute. Plasma samples were immediately distributed into 1.5 ml Eppendorf tubes and centrifuged at 1300 g for 10 minutes. Serum samples were distributed into 1.5 ml Eppendorf tubes, allowed to clot for 30 minutes and centrifuged at 1300 g for 15 minutes. Plasma or serum was removed and frozen at −70 C prior to thaw and subsequent assay with SOMAScan Version 1-J.

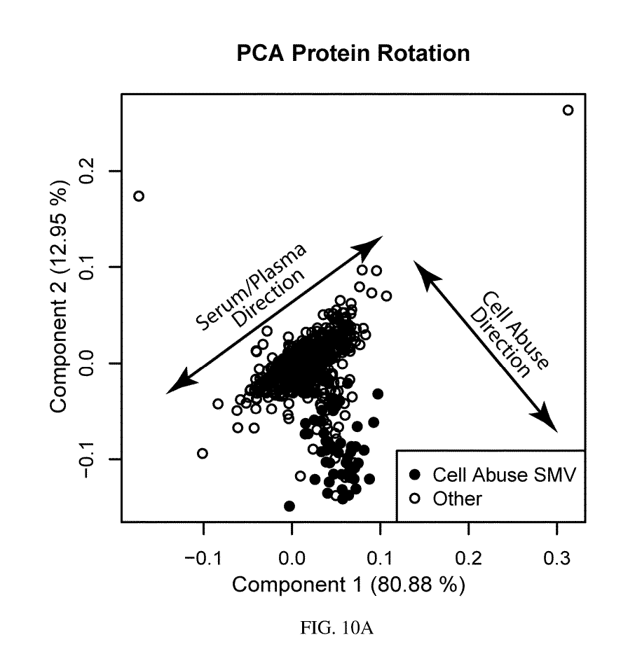

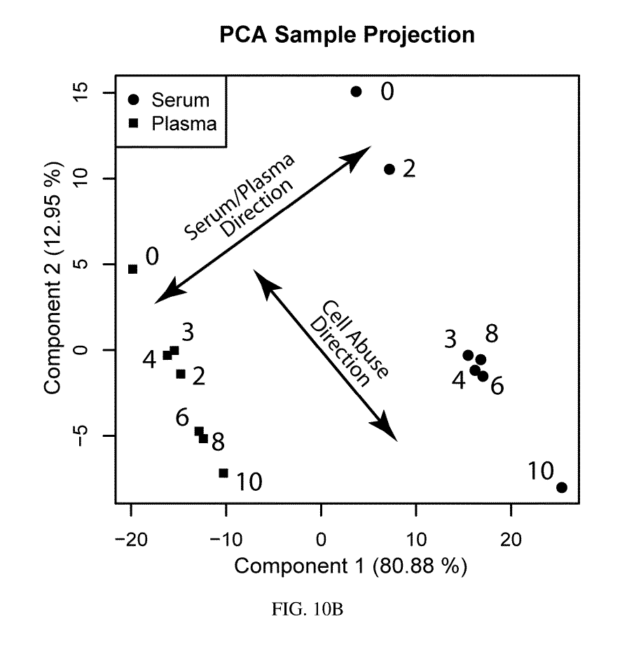

The shear effect of passing the sample through a 21½ gauge needle was meant to rapidly simulate the cell abuse that occurs in a sample that is left unprocessed for long periods of time. FIGS. 10A and 10B show plots of the first two principal components of this experiment. FIG. 10A shows the rotation plot, which reflects the variation in the proteins. The analytes in the both the serum and plasma Cell Abuse SMVs are indicated as solid dots while the remaining hollow dots represent the remaining analytes. There are two major directions of variation in this plot, which were labeled the plasma/serum direction and the cell abuse direction. The serum versus plasma direction is dominated by proteins involved in the clotting of serum, such as thrombin. The other direction is enriched for the analytes in the Cell Abuse SMVs.

FIG. 10B shows the corresponding projection matrix, which reflects the variation in the samples. This shows a clear separation between the serum and plasma samples, which corresponds to the serum versus plasma direction in FIG. 10A. The other direction orders both the serum and plasma samples relative the number of times the sample was passed through the needle, although some points are slightly out of order. This indicates that concentration of the proteins in this direction increases as the number of passages through the needle increases.

This experiment revealed that a set of analytes increases in concentration as they are repeatedly passed through a needle. Furthermore, this set of analytes is highly enriched for proteins from the Cell Abuse SMV. The fact that the Cell Abuse SMV analytes appear in the first two principal components demonstrates that this protein signature is a major source of variation in this study and can be identified in an unsupervised manner.

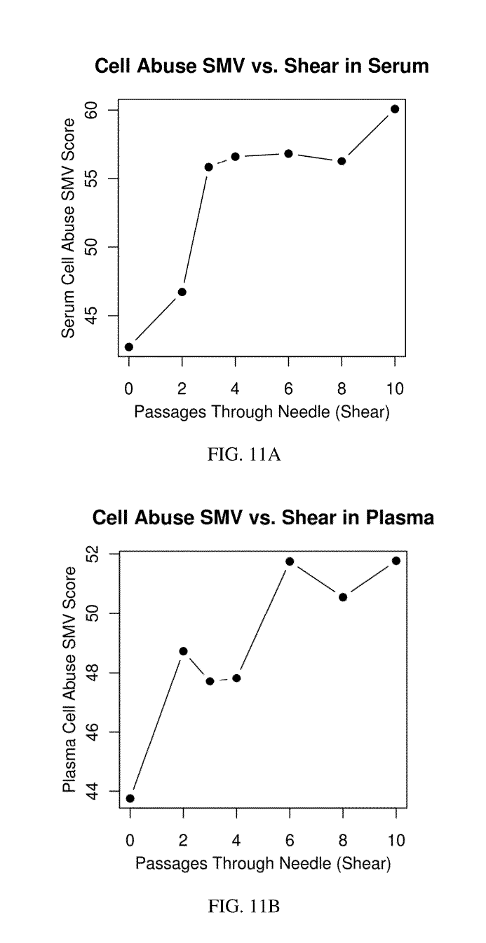

FIGS. 11A and 11B show the Cell Abuse SMV scores for serum and plasma, respectively. These plots show a clear increase in cell abuse as the degree of needle induced shear increases. This experiment confirms the fact that the Cell Abuse SMVs for both serum and plasma measure the degree of cellular abuse and lysis. This was observed in both an unsupervised (FIG. 10) and supervised (FIG. 11) approach.

### Example 8

### Experimental Validation of Plasma Platelet SMV Via TRAP Activation

Sixteen samples were obtained by venipuncture using a 21 gauge needle appended to a purple-top Vacutainer. Samples were distributed (0.5 ml aliquots) into 0.5 ml Eppendorf tubes containing 10 uL DMSO. Half the samples were treated with 10 uL 1 mM Thrombin Receptor Activating Peptide (TRAP) in DMSO (20 uM final concentration). Samples were incubated at room temperature for either 0, 0.5, 1, 2, 4, 8, 12, or 20 hours and spun at 1300 g for 10 minutes prior to recovery and freezing at −70 C. Samples were thawed and assayed via SOMAScan Version 1-J.

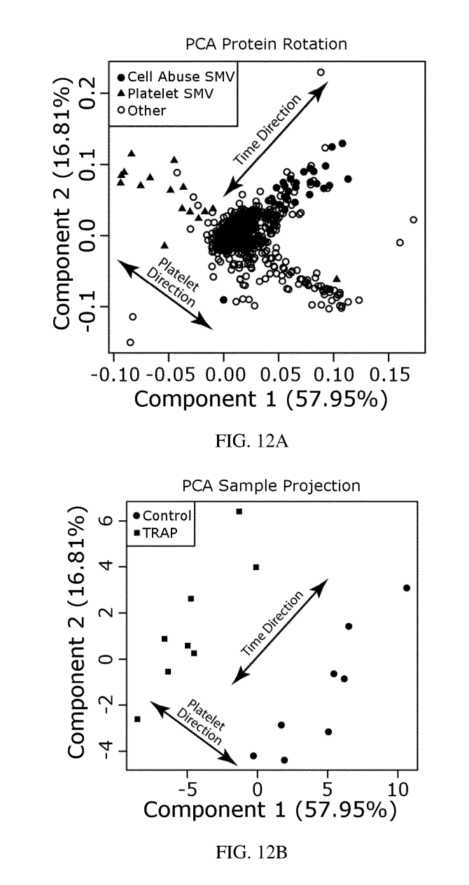

FIGS. 12A and 12B show plots of the first two principal components of this experiment. FIG. 12A shows the rotation plot, which reflects the variation in the proteins. The analytes in the plasma Cell Abuse SMV are shown as solid circles and the analytes in the plasma Platelet SMV are shown as solid triangles. The remaining analytes are indicated as hollow dots. There are two major directions of variation in this plot, which were labeled the platelet direction and the time direction. FIG. 12A shows that the analytes in the direction associated with TRAP activation are highly enriched with analytes from the Plasma Platelet SMV (solid triangles). Furthermore, the analytes in the direction associated with time are highly enriched with analytes from the Plasma Cell Abuse SMV, as observed previously. This supports the assertion that these two SMVs are measuring two different effects.

FIG. 12B shows the corresponding projection matrix, which reflects the variation in the samples. This shows a clear separation between the TRAP activated samples and the corresponding controls. The other direction is associated with the time before the sample was spun.

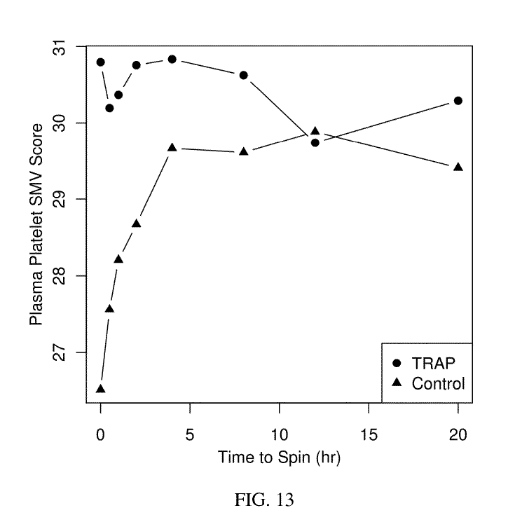

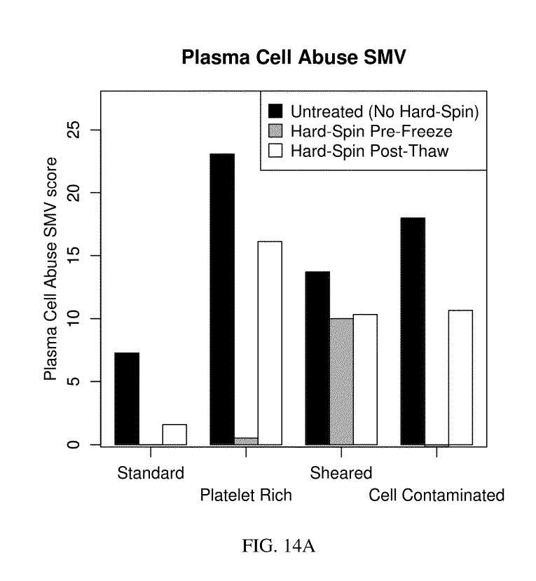

FIG. 13 shows a scatter plot of the plasma Platelet SMV versus time to spin in hours for the TRAP treated samples and controls. The control samples show an increase in Platelet SMV score with time, which plateaus after around five hours. This suggests that even though the plasma sample contains anti-coagulants, eventually the sample begins to clot. The TRAP activated samples show a consistent high Platelet SMV score, regardless of the time before the sample was spun. This suggests that the addition of the TRAP activated the platelets immediately and to comparable levels of the control samples after 5 hours of incubation. This experiment shows that the plasma Platelet SMV measure platelet activation via TRAP activation.

### Example 9

### Hard Spin Post-Thaw to Reduce Sample Contamination

An experiment was designed to test the efficacy of conducting a hard-spin (4000 g for ten minutes) after freeze-thaw to remove cellular and platelet contamination from a sample. Plasma collected using a standard protocol was compared to applying a hard-spin either before or after freeze-thaw. The hard-spin conducted prior to freeze-thaw was included as a reference for the hard-spin post-thaw samples to assess the extent of cells lysis and platelet activation caused by the freeze-thaw cycle.

Blood was obtained from a single healthy donor by venipuncture using a 21 gauge needle appended to a purple-top Vacutainer tube and split into four groups: standard, platelet rich, sheared, and cell contaminated. Standard samples (platelet poor) were centrifuged at 1300 g for ten minutes. Platelet rich samples were spun at 600 g for five minutes. Sheared samples were spun at 1300 g for ten minutes and then subjected to a single pass through a 23 gauge needle at roughly 100 mls/minute then returned to a Vacutainer tube. Cell-contaminated samples were centrifuged at 1300 g for ten minutes and then a small amount of material from the cell/plasma interface (buffy coat) was deliberately spiked back into the supernatant. Plasma fractions were recovered by aspiration.

Each sample group was split into three portions which received different treatments. The untreated (no hard-spin) portion (0.5 ml) was frozen without further treatment prior to freeze-thaw. The hard-spin pre-freeze portion was placed into a 1.5 ml Eppendorf tube and centrifuged at 4000 g for ten minutes then frozen. The hard-spin post-thaw portion was frozen, thawed, and then centrifuged at 4000 g for ten minutes in a 1.5 ml Eppendorf tube. All supernatant was recovered by aspiration. All samples were then frozen at −70 C. Samples were analyzed on SOMAScan Version 3.

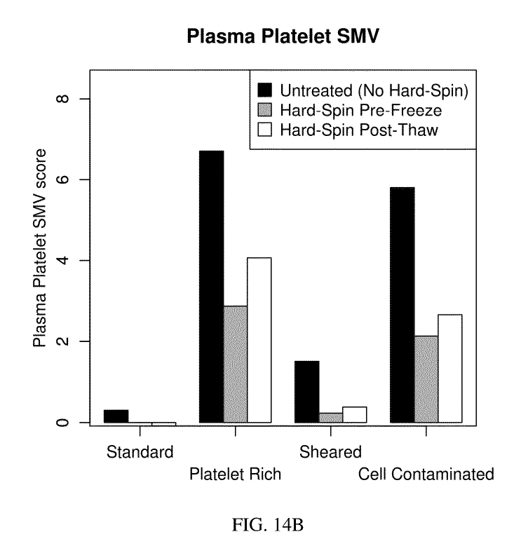

FIGS. 14A and 14B show the results of this experiment. In both figures, the standard sample that received the hard spin prior to freezing was used as a reference and all other SMV scores had this reference value subtracted from them.

FIG. 14A shows the effect of the hard-spin on the plasma Cell Abuse SMV scores. As expected, the standard samples showed the lowest cellular contamination of all the untreated portions. The other three sample groups (platelet rich, sheared, and cell contaminated) all had much higher measured levels of measured cellular abuse in the untreated portions. The hard-spin prior to freeze successfully removed this elevated cell abuse signature in both the platelet rich samples and the cell contaminated sample groups. The sheared group showed a far smaller reduction in the cell abuse signature, indicating that the passage through the needle had already lysed the cells prior to the hard spin. The sample portions that received the hard-spin post-thaw also showed a reduction in the cell abuse signature, however not to the same degree as the sample spun prior to freezing. This suggests that some of the cells were lysed during the freeze-thaw process, but that the application of a hard-spin after freezing still reduced the total cellular contamination and potential lysis in the sample.

FIG. 14B shows a similar effect in the measured platelet activation. In the standard sample group, the platelet activation is low for the untreated portion and both hard-spins reduce this signature a comparable amount. As seen with the Cell Abuse SMV scores, the Platelet SMV scores are decreased substantially by applying a hard-spin after thawing, albeit not to the same degree as when the hard-spin is applied prior to freezing. This also suggests that although a freeze-thaw cycle does activate some platelets, there is still utility in performing a hard-spin after the sample has been thawed and prior to running an assay.

This experiment shows that a post-thaw hard-spin can reduce the cellular contamination and platelet activation of a sample. Although some portion of the cells and platelets are affected by the freeze-thaw, some persist in a state that a hard-spin is able to remove. These findings are especially relevant for retrospective collections which may have been processed under an undesired collection protocol. Regardless of how well these retrospective samples were collected, this study shows that a hard spin after thawing results in samples with less cellular contamination and platelet activation.

TABLE 1
Markers Useful as Sample Handling and Processing Markers
Members of each SMV are designated by “X”.

| | Sample | | | | | | | |
|---|---|---|---|---|---|---|---|---|
| | Processing | | | | Serum | Plasma | | |
| | Marker | Entrez | SwissProt | | Cell | Cell | Plasma | |
| # | Designation | Gene ID | ID | Public Name | Abuse | Abuse | Platelet | Complement |
| 1 | ACP1 | 52 | P24666 | PPAC | X | | | |
| 2 | ADRBK1 | 156 | P25098 | BARK1 | X | X | | |
| 3 | AKT3 | 10000 | Q9Y243 | PKB gamma | | X | | |
| 4 | ANGPT1 | 284 | Q15389 | Angiopoietin-1 | | | X | |
| 5 | APP | 351 | P05067 | amyloid | | | X | |
| | | | | precursor | | | | |
| | | | | protein | | | | |
| 6 | BDNF | 627 | P23560 | BDNF | | | X | |
| 7 | BTK | 695 | Q06187 | BTK | | X | | |
| 8 | C3 | 718 | P01024 | iC3b | | | | X |
| 9 | C3 | 718 | P01024 | C3 | | | | X |
| 10 | C3 | 718 | P01024 | C3adesArg | | | | X |
| 11 | CA13 | 377677 | Q8N1Q1 | Carbonic | | X | | |
| | | | | anhydrase XIII | | | | |
| 12 | CAMK2D | 817 | Q13557 | CAMK2D | | X | | |
| 13 | CAPN1- | 823; 826 | P07384; | Calpain I | X | X | | |
| | CAPNS1 | | P04632 | | | | | |
| 14 | CASP3 | 836 | P42574 | Caspase-3 | X | X | | |
| 15 | CCL5 | 6352 | P13501 | RANTES | | | X | |
| 16 | CD84 | 8832 | Q9UIB8 | SLAMF5 | | X | | |
| 17 | CSK | 1445 | P41240 | CSK | X | X | | |
| 18 | CTSA | 5476 | P10619 | Cathepsin A | | | X | |
| 19 | CYP3A4 | 1576 | P08684 | Cytochrome | | X | | |
| | | | | P450 3A4 | | | | |
| 20 | DKK4 | 27121 | Q9UBT3 | Dkk-4 | | | X | |
| 21 | DYNLRB1 | 83658 | Q9NP97 | DLRB1 | | X | | |
| 22 | EIF5A | 1984 | P63241 | eIF-5A-1 | X | | | |
| 23 | FYN | 2534 | P06241 | FYN | | X | | |
| 24 | GDI2 | 2665 | P50395 | Rab GDP | X | X | | |
| | | | | dissociation | | | | |
| | | | | inhibitor beta | | | | |
| 25 | GSK3A | 2931 | P49840 | GSK-3 alpha | X | X | | |
| 26 | GSK3B | 2932 | P49841 | GSK-3 beta | | X | | |
| 27 | HSP90AA1 | 3320 | P07900 | HSP 90alpha | X | X | | |
| | HSP90AB1 | 3326 | P08238 | HSP 90beta | X | X | | |
| 28 | HSPA1A | 3303 | P08107 | HSP 70 | X | X | | |
| 29 | HSPD1 | 3329 | P10809 | HSP 60 | | X | | |
| 30 | IDE | 3416 | P14735 | Insulysin | X | X | | |
| 31 | KPNB1 | 3837 | Q14974 | Importin beta1 | X | X | | |
| 32 | LTA4H | 4048 | P09960 | LTA-4 hydrolase | | | | X |
| 33 | LYN | 4067 | P07948 | LYN B | | X | | |
| 34 | LYN | 4067 | P07948 | LYN A | | X | | |
| 35 | MAPK1 | 5594 | P28482 | MAPK1 | X | X | | |
| 36 | MAPK3 | 5595 | P27361 | MAPK3 | X | X | | |
| 37 | MAPKAPK2 | 9261 | P49137 | MAPKAPK2 | | X | | |
| 38 | MAPKAPK3 | 7867 | Q16644 | MAPKAPK3 | X | X | | |
| 39 | MDH1 | 4190 | P40925 | MDHC | X | X | | |
| 40 | MDK | 4192 | P21741 | Midkine | | | X | |
| 41 | METAP1 | 23173 | P53582 | MetAP 1 | | X | | |
| 42 | METAP2 | 10988 | P50579 | MetAP2 | | X | | |
| 43 | MMP9 | 4318 | P14780 | MMP-9 | | | X | |
| 44 | NACA | 4666 | Q13765 | NACalpha | X | X | | |
| 45 | NAGK | 55577 | Q9UJ70 | NAGK | | X | | |
| 46 | PAFAH1B2 | 5049 | P68402 | PAFAH beta | X | X | | |
| | | | | subunit | | | | |
| 47 | PAK6 | 56924 | Q9NQU5 | PAK6 | | X | | |
| 48 | PDGFB | 5155 | P01127 | PDGF-BB | | | X | |
| 49 | PF4 | 5196 | P02776 | PF-4 | | | X | |
| 50 | PGAM1 | 5223 | P18669 | Phosphoglycerate | | X | | |
| | | | | mutase 1 | | | | |
| 51 | PIK3CA- | 5290; 5295 | P42336; | PIK3Calpha/PIK3R1 | | X | | |
| | PIK3R1 | | P27986 | | | | | |
| 52 | PPBP | 5473 | P02775 | NAP-2 | | | X | |
| 53 | PPIA | 5478 | P62937 | Cyclophilin A | X | X | | |
| 54 | PRDX1 | 5052 | Q06830 | Peroxiredoxin-1 | X | X | | |
| 55 | PRKACA | 5566 | P17612 | PRKA C-alpha | X | X | | |
| 56 | PRKCA | 5578 | P17252 | PKC-alpha | | X | | |
| 57 | PRKCI | 5584 | P41743 | PRKCI | X | | | |
| 58 | RAC1 | 5879 | P63000 | RAC1 | X | X | | |
| 59 | RPS6KA3 | 6197 | P51812 | RPS6Kalpha3 | X | X | | |
| 60 | RPS7 | 6201 | P62081 | RS7 | X | | | |
| 61 | SELP | 6403 | P16109 | P-Selectin | | X | | |
| 62 | SERPINE1 | 5054 | P05121 | PAI-1 | | | X | |
| 63 | SERPINE2 | 5270 | P07093 | Protease nexin I | | | X | |
| 64 | SNX4 | 8723 | 095219 | Sorting nexin 4 | | X | | |
| 65 | SPARC | 6678 | P09486 | Osteonectin | | | X | |
| 66 | STIP1 | 10963 | P31948 | Stress-induced- | X | | | |
| | | | | phosphoprotein 1 | | | | |
| 67 | THBS1 | 7057 | P07996 | Thrombospondin-1 | | | X | |
| 68 | TIMP3 | 7078 | P35625 | TIMP-3 | | | X | |
| 69 | TPT1 | 7178 | P13693 | Fortilin | | X | | |
| 70 | UBE2I | 7329 | P63279 | UBC9 | X | X | | |
| 71 | UBE2N | 7334 | P61088 | UBE2N | X | X | | |
| 72 | UFC1 | 51506 | Q9Y3C8 | UFC1 | X | X | | |
| 73 | UFM1 | 51569 | P61960 | UFM1 | | X | | |

TABLE 2
Biomarkers and SMV Coefficients for Serum Cell Abuse

| Protein | SMV Coefficient |
|---|---|
| HSP90AA1 | 0.1311 |
| HSP90AB1 | 0.1029 |
| PAFAH1B2 | 0.1216 |
| GDI2 | 0.1704 |
| CAPN1.CAPNS1 | 0.1349 |
| MAPK3 | 0.2045 |
| RAC1 | 0.2475 |
| UBE2I | 0.2276 |
| MAPK1 | 0.1924 |
| IDE | 0.1405 |
| ADRBK1 | 0.2357 |
| CSK | 0.3035 |
| PRKCI | 0.0941 |
| UFC1 | 0.1167 |
| GSK3A | 0.1540 |
| PRKACA | 0.2391 |
| RPS6KA3 | 0.1901 |
| CASP3 | 0.1996 |
| MAPKAPK3 | 0.1794 |
| PPIA | 0.2163 |
| MDH1 | 0.1847 |
| NACA | 0.1025 |
| PRDX1 | 0.1269 |
| ACP1 | 0.0436 |
| RPS7 | 0.0959 |
| STIP1 | 0.0573 |
| EIF5A | 0.0660 |
| KPNB1 | 0.2269 |
| UBE2N | 0.2246 |
| HSPA1A | 0.1912 |

TABLE 3
Biomarkers and SMV Coefficients for Plasma Cell Abuse

| Protein | SMV Coefficient |
|---|---|
| HSP90AA1 | 0.0720 |
| HSP90AB1 | 0.0596 |
| PAFAH1B2 | 0.0582 |
| PRKCA | 0.1447 |
| GDI2 | 0.0815 |
| CAPN1.CAPNS1 | 0.0662 |
| HSPD1 | 0.1340 |
| MAPK3 | 0.1466 |
| RAC1 | 0.1492 |
| UBE2I | 0.1333 |
| CYP3A4 | 0.0815 |
| MAPK1 | 0.1268 |
| METAP2 | 0.1161 |
| IDE | 0.0701 |
| METAP1 | 0.1773 |
| GSK3B | 0.1046 |
| ADRBK1 | 0.1761 |
| CSK | 0.2003 |
| LYN | 0.1725 |
| PIK3CA.PIK3R1 | 0.0600 |
| AKT3 | 0.1457 |
| UFC1 | 0.0797 |
| BTK | 0.2330 |
| CAMK2D | 0.1126 |
| CA13 | 0.0630 |
| GSK3A | 0.1233 |
| LYN | 0.1857 |
| PRKACA | 0.1265 |
| RPS6KA3 | 0.1226 |
| CASP3 | 0.1356 |
| CD84 | 0.0687 |
| FYN | 0.1016 |
| MAPKAPK2 | 0.1050 |
| MAPKAPK3 | 0.1436 |
| PAK6 | 0.1388 |
| UFM1 | 0.1171 |
| PPIA | 0.1470 |
| DYNLRB1 | 0.0630 |
| MDH1 | 0.1001 |
| NACA | 0.0710 |
| PRDX1 | 0.0563 |
| TPT1 | 0.1437 |
| KPNB1 | 0.1239 |
| NAGK | 0.0623 |
| PGAM1 | 0.1404 |
| SNX4 | 0.0792 |
| UBE2N | 0.1261 |
| HSPA1A | 0.0948 |
| SELP | 0.0586 |

TABLE 4
Biomarkers and SMV Coefficients for Plasma Platelet Activation

| Protein | SMV Coefficient |
|---|---|
| BDNF | 0.1313 |
| TIMP3 | 0.2189 |
| CCL5 | 0.1726 |
| MMP9 | 0.1597 |
| PF4 | 0.2456 |
| ANGPT1 | 0.1702 |
| MDK | 0.1195 |
| PPBP | 0.2103 |
| SERPINE1 | 0.1671 |
| SPARC | 0.2307 |
| APP | 0.2429 |
| CTSA | 0.1339 |
| SERPINE2 | 0.2668 |
| DKK4 | 0.1536 |
| THBS1 | 0.1752 |
| PDGFB | 0.2664 |

TABLE 5
Biomarkers and SMV Coefficients for Complement Activation

| Protein | SMV Coefficient |
|---|---|
| C3 | 0.0825 |
| C3 | 0.1369 |
| C3 | 0.0665 |
| LTA4H | 0.1937 |

TABLE 6
Number of analytes (out of 868 total) significantly different
(q-value < 0.05) when collected using the 24-hour and 48-hour protocols
versus the 2-hour preferred protocol. For each protocol, the number of
significantly affected analytes that increased or decreased in
concentration as a result of the collection protocol is shown.

| | SHN 24-Hour | | SHN 48-Hour | |
|---|---|---|---|---|
| Tube Type | Increased | Decreased | Increased | Decreased |
| EDTA Plasma | 36 | 1 | 167 | 153 |
| P100 Plasma | 3 | 1 | 113 | 85 |
| SST Serum | 15 | 2 | 48 | 33 |

1. A method of identifying a sample handling/processing marker useful in quantifying sample quality, comprising:
a) determining a first set of analytes that are differentially expressed:
(i) when a handling/processing protocol is varied, or
(ii) when a specific biological process is experimentally activated or varied;
b) determining a subset of those analytes that change wherein the analyte measurements are smoothly or linearly related:
(i) to the degree of handling/processing protocol variation applied, or
(ii) to the degree of experimental activation of a biological process applied to the sample; wherein the subset can contain the same or less analytes compared to the first set of analytes;
c) building a quantitative model for the dependence between:
(i) the variation in sample handling protocol and the measurements of analytes from the subset; or
(ii) the degree of experimental activation of a biological process applied to the sample and the analyte measurements from the subset; and
d) providing a metric or score for each sample based upon the quantitative model of step (c).

2. A method of determining sample quality of a sample comprising:
a) providing the sample handling/processing markers of claim 1 for said sample;
b) applying the quantitative model from claim 1 to provide a metric or score for the sample, wherein the metric or score indicates to what extent the sample is produced by methods deviating by the preferred protocol;
c) using the metric or score:
(i) to reject or accept the sample for diagnostic purposes;
(ii) to reject or accept the sample for biomarker discovery applications;
(iii) to determine the extent of variation from sample handling protocol by comparison with a reference sample;
(iv) to correct for variation in sample handling protocol;
(v) to reject samples, whereby acceptable sample groups for biomarker discovery can be provided; and/or
(vi) to reject samples to avoid misleading results in a diagnostic test setting.

3. A method for selecting a subset of samples suitable for biomarker discovery comprising:
a) calculating the quantitative metric for each sample:
(i) for samples in a set intended for biomarker discovery, or
(ii) from a plurality of collections of samples;
b) selecting from step (a):
(i) samples of the set that meet acceptable ranges for quantitative metric, or
(ii) samples from a subset of the collections which meet a common range of acceptable metrics;
c) rejecting samples of step (a) showing association between the metric and the biological distinction targeted for biomarker discovery.

4. A method for rejecting an entire collection comprising:
a) selecting a subset of the samples, wherein the subset comprises all the samples of the collection or a random subset;
b) calculating quantitative metric for each sample in the subset;
c) determining the proportion or distribution of samples that meet acceptable ranges for quantitative metric;
d) determining whether to reject the collection based upon:
(i) the distribution or proportion of acceptable samples; and/or
(ii) the degree of the association between the clinical variation of interest and the quantitative metric.

5. A method of improving the quality of a sample comprising:
a) separating a plasma supernatant from cells and cellular components of a sample of an individual;
b) freezing the plasma supernatant;
c) thawing the plasma supernatant; and
d) conducting a second spin of the thawed supernatant, whereby the sample of improved quality is produced, wherein the spin is a clinical standard centrifuge spin for whole blood and/or the spin has a product of acceleration greater than 2500 g for 10 minutes.

6. The method of claim 5, wherein the thawed plasma supernatant is first transferred to a tube of sufficient strength that can withstand increased gravity (g), spin time and path length, before the second spin.

7. The method of claim 6, wherein the tube of sufficient strength is an Eppendorf® tube.

8. A method of screening a sample or a sample set for its handling/processing marker values variability comprising:
determining in said sample or sample set, handling/processing marker values that correspond to one of at least N markers selected from Table 1, wherein N=2-73;
providing a reference sample and determining the handling/processing marker values that correspond to the measured sample or sample set handling/processing markers; and
comparing the sample or sample set handling/processing marker values to corresponding handling/processing marker values of the reference sample, whereby the handling/processing marker value variability of the sample or sample set can be determined.

9. The method of claim 8, wherein the at least N markers are selected from Table 2, and wherein N=2-30.

10. The method of claim 8, wherein the at least N markers are selected from Table 3, and wherein N=2-52.

11. The method of claim 8, wherein the at least N markers are selected from Table 4, and wherein N=2-17.

12. The method of claim 8, wherein the at least N markers are selected from Table 5, and wherein N=2-4.

13. A method for determining the suitability of a sample or sample set for further analysis, comprising the method of claim 8, and further comprising:
providing the sample or sample set handling/processing marker value variability;
determining from said variability whether the sample or sample set does not exceed predetermined cut-off values;
whereby the suitability of a sample or sample set is determined by said sample or sample set having handling/processing marker values that do not exceed the cut-off values.

14. The method of claim 8, wherein prior to said determining step, each said handling/processing marker value of the sample or sample set is processed according to the steps of:
obtaining the natural log value of each of the handling/processing marker; and
weighting each of the natural log values according to a predetermined Sample Mapping Vector (SMV) coefficient to obtain a product for each said handling/processing marker value of the sample or sample set;
wherein said comparing of each said handling/processing marker value comprises comparing their weighted product.

15. A method for determining a preferred sample handling and processing protocol, wherein said protocol generates samples suitable for further analysis, comprising the method of claim 8 and further comprising:
a) determining, from said handling/processing marker value variability, markers that are sensitive to variations in said protocol procedures;
b) varying protocol procedures to minimize the handling/processing marker value variability of said sensitive markers, whereby a preferred protocol can be determined.

16. A method for determining compliance of a sample or sample set with predetermined collection protocol, comprising the method of claim 5, and further comprising:
providing a reference sample that has undergone the predetermined collection protocol;
determining from the reference sample, a cut-off value corresponding to each of said at least N markers;
comparing the handling/processing value of each sample or sample set with the corresponding cut-off value;
identifying the sample or sample set having handling/sampling value variability that exceeds the cut-off value and the sample or sample set that do not exceed the cut-off value, wherein the sample or sample set whose variability does not exceed the cut-off value is in compliance with the predetermined collection protocol.

17. The method of claim 10 wherein the further analysis comprises identification of at least one reliable biomarker, said method comprising:
providing the sample or sample set suitable for further analysis, wherein each said sample or sample set is known to be obtained from a diseased individual or a non-diseased individual;
assaying the sample or sample set to identify the at least one reliable biomarker, wherein said biomarker is substantially differentially expressed in samples or sample sets from the diseased individual relative to corresponding markers in samples or sample sets from individuals who are not diseased;
whereby reliable biomarkers suitable for further analysis are identified markers having substantially differentially expressed values in the diseased state as compared corresponding markers in individuals who are not diseased.

18. The method of claim 10, wherein the further analysis comprises identification of at least one robust biomarker, said method comprising:
providing the suitable samples or sample sets from diseased individuals and from non-diseased individuals;
identifying biomarkers that are not detected in substantially all of the samples or sample sets from diseased individuals;
identifying as robust biomarkers, the biomarkers that are detected in substantially all of the samples or sample sets from diseased individuals.

19. A method for determining a sample quality standard comprising a normal range or preferred cut-off values, for identification of a sample or sample set that is suitable for further analysis, said method comprising:
providing at least one control sample;
determining sample/handling marker value variability in the control sample according to the method of claim 5;
determining the handling/processing markers that are sensitive to variations in sample handling and processing protocol;
defining for each said sample handling/processing marker that is sensitive to protocol variations, a normal range and preferred cut-off values for each said handling/processing marker;
wherein said sample quality standard comprises said preferred cut-off values, and samples or sample sets can be screened using said preferred cut-off values, whereby a suitable sample or sample set can be obtained.

20. The method of claim 10, wherein the further analysis is selected from the group consisting of a determination of reliable biomarkers and a determination of robust biomarkers.

21. A method for determining bias of a sample handling/processing marker in a sample or sample set, comprising:
identifying in the suitable samples or sample sets provided according to the method of claim 10, sample handling/processing markers that are sensitive to variations in sample collection and handling protocol;
providing a reference or control sample;
measuring said sensitive sample handling/processing marker values in the suitable samples or sample sets and in the reference sample;
comparing the measured sample or sample set handling/processing marker values to the reference sample handling/processing marker values;
identifying handling/processing marker values of the sample or sample set that vary from the reference sample handling/processing marker value;
distinguishing in said handling/processing markers having value variation from said reference marker value, the sample handling/processing markers that mimic disease biomarker value variation;
wherein the distinguished handling/processing markers that mimic disease biomarkers are biased handling/processing markers; and
wherein the biased handling/processing markers can be eliminated from further analysis.

22. A method for correcting the measured biomarker value of a sample,
measuring the handling/processing marker value variability of the sample according to the method of claim 5;
identifying a change in handling/processing marker values of the sample relative to the handling/processing marker values of the reference; and
correcting the sample's biomarker measurement in accordance with the identified change in sample handling/processing marker values relative to the handling/processing values of the reference sample.
